(19) United States
(12) Patent Application Publication
(10) Pub. No.: US 2015/0254926 A1
(43) Pub. Date: Sep. 10, 2015

(54) GAMING MACHINE

(71) Applicants: Universal Entertainment Corporation, Tokyo (JP); Aruze Gaming America, Inc.

(72) Inventors: Takehisa ITAGAKI, Tokyo (JP); Yuji Miyagawa, Tokyo (JP); Yoichi Kato, Tokyo (JP); Hideko Aoki, Tokyo (JP)

(21) Appl. No.: 14/623,723

(22) Filed: Feb. 17, 2015

(30) Foreign Application Priority Data
Mar. 4, 2014 (JP) 2014-042179

(51) Int. Cl. G07F 17/32; G07F 17/34

(52) U.S. Cl. CPC G07F 17/3213; G07F 17/34

(57) ABSTRACT

Provided is a gaming machine capable of avoiding monotonousness upon executing free games in a bonus game and realizing a variety of game patterns. When a free game trigger is established, the gaming machine controls a game to shift from a basic game to the free games. In the free games, when as a result of the rearrangement of randomly determined symbols, four consecutive special symbols are rearranged in symbol display regions 4 which correspond to any of video reels 3a to 3e and at least one special symbol whose kind is the same is rearranged on a video reel 3 which is different from said video reel 3, scrolling in an upward direction or a downward direction is further conducted, and four consecutive special symbols are rearranged.

### CROSS-REFERENCE TO RELATED APPLICATION

This application claims the benefit of Japanese Patent Application No. 2014-042179, filed on Mar. 4, 2014, which application is incorporated herein by reference in its entirety.

### FIELD OF THE INVENTION

The present invention relates to a gaming machine.

### BACKGROUND OF THE INVENTION

Conventionally, there has been known a gaming machine in which when subsequent to the insertion of gaming media such as coins, a player presses a spin button, random numbers for determination of symbols are extracted; symbols to be displayed for a player upon stopping a plurality of video reels displayed on a display are determined; scrolling of symbol arrays of the respective video reels is started; the scrolling is stopped so as to display the determined symbols for a player and the symbols are rearranged; it is determined whether or not a combination of the displayed symbols is associated with winning; and in a case where the combination of the displayed symbols is associated with the winning, a benefit in accordance with a kind of the combination of the symbols is awarded to a player.

In such a gaming machine, upon winning a BB related to the activation of a bonus, a number of gaming media which can be paid out in a bonus game is determined and set (for example, refer to Japanese Patent Application Laid-Open Publication No. 2007-20954). On this gaming machine, a player can play the bonus game until the set number of gaming media which can be paid out has been reached.

However, in such a gaming machine, after winning the BB related to the activation of the bonus, the game is merely played until the determined number of the medals which can be paid out have been paid out. Therefore, a player merely consumes the predetermined number of medals which can be paid out, and thus, a variety of game patterns cannot be provided for a player.

Accordingly, an object of the present invention is to provide a gaming machine capable of avoiding monotonousness upon executing free games and of realizing a variety of game patterns by controlling the rearrangement of the symbols on scroll lines in the free games in a bonus game, which is different from the rearrangement of the symbols in a basic game.

### BRIEF SUMMARY OF THE INVENTION

According to a first aspect of the present invention, provided is a gaming machine in which a payout is determined based on rearranged symbols, comprising

a controller for controlling a game in which along a plurality of scroll lines defined in display regions of a display, a plurality of symbols including a predetermined number or more of consecutive particular symbols are displayed in a moving manner and are rearranged, the controller being programmed to execute processing (1-1) to (1-4) described below.

Here, in the processing (1-1), symbols to be rearranged in a first game are randomly determined;

in the processing (1-2), when the randomly determined and rearranged symbols in the first game satisfy a first condition, a second game is controlled to be started;

in the processing (1-3), symbols to be rearranged in the second game are randomly determined; and

in the processing (1-4), when as a result of the rearrangement of the randomly determined symbols in the second game, the predetermined number of the particular symbols are consecutively rearranged on any of the plurality of scroll lines and at least one of the particular symbols is rearranged on a scroll line which is different from the scroll line on which the predetermined number of the particular symbols have been consecutively rearranged, the predetermined number of the particular symbols are consecutively rearranged on said scroll line on which the at least one of the particular symbols has been rearranged.

By employing the configuration of the above-described aspect of the present invention, when the predetermined number of the particular symbols are consecutively rearranged on any of the scroll lines in the second game and the at least one of the particular symbols is once rearranged on any of the other scroll lines, the predetermined number of said particular symbols are consecutively rearranged. Thus, not only a sense of expectation that the particular symbols are likely to be rearranged is enhanced, but also monotonousness in the second game is avoided and a player is provided with a variety of game patterns.

According to a second aspect of the present invention, in the above-described first aspect, a number of symbols to be rearranged on each of the scroll lines defined in the display regions is a predetermined number,

the predetermined number or more of the particular symbols are consecutively arranged previously in symbol arrays in which the plurality of symbols are arranged, and

the processing (1-4) includes processing in which when as the result of the rearrangement of the randomly determined symbols in the second game, the predetermined number of the particular symbols are consecutively rearranged on any of the plurality of scroll lines and the at least one of the particular symbols is rearranged on the scroll line which is different from the scroll line on which the predetermined number of the particular symbols have been consecutively rearranged, the symbol arrays are nudged in the same direction in which the plurality of symbols are displayed in the moving manner or in a direction opposite to the same direction such that the predetermined number of the particular symbols are consecutively rearranged on said scroll line on which the at least one of the particular symbols has been rearranged.

By employing the configuration of the above-described aspect of the present invention, when the predetermined number of the particular symbols are consecutively rearranged on any of the scroll lines in the second game and the at least one particular symbol is once rearranged on any of the other scroll lines, the symbol arrays are nudged on said scroll line on which the at least one particular symbol has been once rearranged, whereby the predetermined number of said particular symbols are consecutively rearranged. Thus, not only a sense of expectation that the particular symbols are likely to be rearranged is enhanced, but also monotonousness in the second game is avoided and a player is provided with a variety of game patterns. Here, to nudge is to move the symbol arrays in a vertical direction or a direction opposite thereto such that the particular symbols are rearranged in all regions of the display regions in the vertical direction, on the scroll line on which the at least one particular symbol has been rearranged.

According to a third aspect of the present invention, in the above-described second aspect, provided is the gaming machine in which the controller further executes processing (1-5) described below.

Here, in the processing (1-5), as a result of the processing (1-4), when the predetermined number of the particular symbols are consecutively rearranged on all of the plurality of scroll lines, a jackpot is provided.

By employing the configuration of the above-described aspect of the present invention, when the predetermined number of the particular symbols are consecutively rearranged on any of the scroll lines in the second game and the at least one particular symbol is once rearranged on each of the other scroll lines, the symbol arrays are nudged on all of the scroll lines, whereby the predetermined number of the particular symbols are consecutively rearranged on all of the scroll lines and the jackpot is thereby provided. Thus, not only a sense of expectation that the particular symbols are likely to be rearranged is enhanced, but also monotonousness in the second game is avoided and a player is provided with a variety of game patterns.

According to a fourth aspect of the present invention, in the above-described second aspect, the processing (1-2) includes processing (1-2-1) in which upon starting the second game, a number of games in the second game is set to a predetermined number of games, and the second game is controlled such that the second game is repeated until the number of games in the second game reaches zero, and

the processing (1-4) includes processing (1-4-1) in which when rearranged symbols in the second game satisfy the first condition (for example, when a retrigger is established), the predetermined number of games is added to a number of games in the second game.

By employing the configuration of the above-described aspect of the present invention, the combination of symbols in the first game which causes the game to shift to the second game serves to increase the number of games in the second game. Thus, monotonousness in the second game is avoided and a player is provided with a variety of game patterns.

According to a fifth aspect of the present invention, provided is a gaming machine in which a payout is determined based on rearranged symbols, comprising

a controller for controlling a game in which along a plurality of scroll lines defined in display regions of a display, a plurality of symbols including a predetermined number or more of consecutive particular symbols are displayed in a moving manner and are rearranged, the controller being programmed to execute processing (2-1) to (2-4) described below.

Here, in the processing (2-1) in which symbols to be rearranged in a first game are randomly determined;

in the processing (2-2) in which when the randomly determined and rearranged symbols in the first game satisfy a first condition, a second game is controlled to be started;

in the processing (2-3) in which symbols to be rearranged in the second game are randomly determined; and

in the processing (2-4) in which when as a result of the rearrangement of the randomly determined symbols in the second game, the predetermined number of the particular symbols are consecutively rearranged on a scroll line, among the plurality of scroll lines, on which symbols have been initially rearranged and at least one of the particular symbols is rearranged on a scroll line which is different from said scroll line on which the symbols have been initially rearranged, the predetermined number of the particular symbols are consecutively rearranged on said scroll line on which the at least one of the particular symbols has been rearranged.

By employing the configuration of the above-described aspect of the present invention, when the predetermined number of the particular symbols are consecutively rearranged on the scroll line on which the symbols have been initially rearranged in the second game and the at least one particular symbol is once rearranged on any of the other scroll lines, the predetermined number of said particular symbols are consecutively rearranged. Thus, not only a sense of expectation that the particular symbols are likely to be rearranged on each of the scroll lines, on which symbols are rearranged secondarily and thereafter, is enhanced, but also monotonousness in the second game is avoided and a player is provided with a variety of game patterns.

According to a sixth aspect of the present invention, in the above-described fifth aspect, a number of symbols to be rearranged on each of the scroll lines defined in the display regions is a predetermined number,

the predetermined number or more of the particular symbols are consecutively arranged previously in symbol arrays in which the plurality of symbols are arranged, and

the processing (2-4) includes processing in which when as the result of the rearrangement of the randomly determined symbols in the second game, the predetermined number of the particular symbols are consecutively rearranged on the scroll line, among the plurality of scroll lines, on which the symbols have been initially rearranged and the at least one of the particular symbols is rearranged on the scroll line which is different from said scroll line on which the symbols have been initially rearranged, the symbol arrays are nudged in the same direction in which the plurality of symbols are displayed in the moving manner or in a direction opposite to the same direction such that the predetermined number of the particular symbols are consecutively rearranged on said scroll line on which the at least one of the particular symbols has been rearranged.

By employing the configuration of the above-described aspect of the present invention, when the predetermined number of the particular symbols are consecutively rearranged on the scroll line on which the symbols have been initially rearranged in the second game and the at least one particular symbol is once rearranged on any of the scroll lines, the symbol array is nudged on said scroll line on which the at least one particular symbol has been once rearranged, whereby the predetermined number of the particular symbols are consecutively rearranged. Thus, not only a sense of expectation that the particular symbols are rearranged on each of the scroll lines, on which symbols are rearranged secondarily and thereafter, is enhanced, but also monotonousness in the second game is avoided and a player is provided with a variety of game patterns.

According to a seventh aspect of the present invention, in the above-described sixth aspect, provided is the gaming machine in which the controller further executes processing (2-5) described below.

Here, in the processing (2-5), as a result of the processing (2-4), when the predetermined number of the particular symbols are consecutively rearranged on all of the plurality of scroll lines, a jackpot is provided.

By employing the configuration of the above-described aspect of the present invention, when the predetermined number of the particular symbols are consecutively rearranged on the scroll line on which the symbols have been initially rearranged in the second game and the at least one particular symbol is once rearranged on each of the other scroll lines, and the predetermined number of the particular symbols are consecutively rearranged by nudging the symbol arrays on all of the scroll lines, whereby the jackpot is provided. Thus, not only a sense of expectation that the particular symbols are rearranged on each of the scroll lines, on which symbols are rearranged secondarily and thereafter, is enhanced, but also monotonousness in the second game is avoided and a player is provided with a variety of game patterns.

According to an eighth aspect of the present invention, in the above-described sixth aspect, the processing (2-2) includes processing (2-2-1) in which upon starting the second game, a number of games in the second game is set to a predetermined number of games, and the second game is controlled such that the second game is repeated until the number of games in the second game reaches zero, and

the processing (2-4) includes processing (2-4-1) in which when rearranged symbols in the second game satisfy the first condition, the predetermined number of games is added to a number of games in the second game.

By employing the configuration of the above-described aspect of the present invention, the combination of symbols in the first game which causes the game to shift to the second game serves to increase the number of games in the second game. Thus, monotonousness in the second game is avoided and a player is provided with a variety of game patterns.

According to a ninth aspect of the present invention, provided is a gaming machine in which a payout is determined based on rearranged symbols, comprising

a controller for controlling a game in which along a plurality of scroll lines defined in display regions of a display, a plurality of symbols including a predetermined number or more of consecutive particular symbols are displayed in a moving manner and are rearranged, the controller being programmed to execute processing (3-1) to (3-5) described below.

Here, in the processing (3-1), symbols to be rearranged in a first game are randomly determined;

in the processing (3-2), when the randomly determined and rearranged symbols in the first game satisfy a first condition, a second game is controlled to be started;

in the processing (3-3), symbols to be rearranged in the second game are randomly determined;

in the processing (3-4), in the second game, at a point in time when symbols are rearranged on a scroll line, among the plurality of scroll lines, on which the symbols are to be initially rearranged, when at least one of the particular symbols is rearranged on said scroll line, a predetermined number of said particular symbols are consecutively rearranged on said scroll line; and

in the processing (3-5), in the second game, when as a result of the rearrangement of the randomly determined symbols on a scroll line which is different from the scroll line on which the predetermined number of the particular symbols have been consecutively rearranged, at least one of the particular symbols is rearranged on said different scroll line, the predetermined number of the particular symbols are consecutively rearranged on said scroll line on which the at least one of the particular symbols has been rearranged.

By employing the configuration of the above-described aspect of the present invention, in response to the at least one particular symbol being rearranged on the scroll line in the second game, on which the symbols have been initially rearranged, the predetermined number of the particular symbols are consecutively rearranged on said scroll line. Thereafter, when the at least one of the particular symbols is once rearranged on each of the other scroll lines, the predetermined number of said particular symbols are consecutively rearranged. Thus, not only a sense of expectation that the at least one of the particular symbols is likely to be rearranged on the scroll line on which the symbols are to be initially rearranged and a sense of expectation that the particular symbols are likely to be rearranged on each of the scroll lines on which the symbols are to be secondarily and thereafter rearranged are enhanced, but also monotonousness in the second game is avoided and a player is provided with a variety of game patterns.

According to a tenth aspect of the present invention, in the above-described ninth aspect, a number of symbols to be rearranged on each of the scroll lines defined in the display regions is a predetermined number,

the predetermined number or more of the particular symbols are consecutively arranged previously in symbol arrays in which the plurality of symbols are arranged, and

the processing (3-4) includes processing in which in the second game, at the point in time when the symbols are rearranged on the scroll line, among the plurality of scroll lines, on which the symbols are to be initially rearranged, when the at least one of the particular symbols is rearranged on said scroll line, the symbol arrays are nudged in the same direction in which the plurality of symbols are displayed in the moving manner or in a direction opposite to the same direction such that the predetermined number of the particular symbols are consecutively rearranged on said scroll line, and

the processing (3-5) includes processing in which in the second game, when as the result of the rearrangement of the randomly determined symbols on the scroll line which is different from the scroll line on which the predetermined number of the particular symbols have been consecutively rearranged, the at least one of the particular symbols is rearranged on said different scroll line, the symbol arrays are nudged in the same direction in which the plurality of symbols are displayed in the moving manner or in the direction opposite to the same direction such that the predetermined number of the particular symbols are consecutively rearranged on said scroll line on which the at least one of the particular symbols has been rearranged.

By employing the configuration of the above-described aspect of the present invention, in response to the at least one particular symbol being rearranged on the scroll line in the second game, on which the symbols have been initially rearranged, the symbol array is nudged on said scroll line, whereby the predetermined number of said particular symbols are consecutively rearranged on said scroll line. Thereafter, when the at least one of the particular symbols is once rearranged on each of the other scroll lines, each of the symbol arrays is nudged on each of the scroll lines on which said at least one of the particular symbols has been rearranged, whereby the predetermined number of said particular symbols are consecutively rearranged on each of the scroll lines on which said at least one of the particular symbols has been rearranged. Thus, not only a sense of expectation that the at least one of the particular symbols is likely to be rearranged on the scroll line on which the symbols are to be initially rearranged and a sense of expectation that the particular symbols are likely to be rearranged on each of the scroll lines on which the symbols are to be secondarily and thereafter rearranged are enhanced, but also monotonousness in the second game is avoided and a player is provided with a variety of game patterns.

According to an 11th aspect of the present invention, in the above-described tenth aspect, the controller further executes processing (3-6) described below.

In the processing (3-6), as a result of the processing (3-5), when the predetermined number of the particular symbols are consecutively rearranged on all of the plurality of scroll lines, a jackpot is provided.

By employing the configuration of the above-described aspect of the present invention, in response to the at least one particular symbol being rearranged on the scroll line in the second game, on which the symbols have been initially rearranged, the symbol array is nudged on said scroll line, whereby the predetermined number of said particular symbols are consecutively rearranged on said scroll line. Thereafter, when the at least one of the particular symbols is once rearranged on each of all of the other scroll lines, the symbol array is nudged on each of the all of the scroll lines, whereby the predetermined number of the particular symbols are consecutively rearranged and the jackpot is thereby provided. Thus, not only a sense of expectation that the at least one of the particular symbols is likely to be rearranged on the scroll line on which the symbols are to be initially rearranged and a sense of expectation that the particular symbols are likely to be rearranged on each of the scroll lines on which the symbols are to be secondarily and thereafter rearranged are enhanced, but also monotonousness in the second game is avoided and a player is provided with a variety of game patterns.

According to a 12th aspect of the present invention, in the above-described tenth aspect, the processing (3-2) includes processing (3-2-1) in which upon starting the second game, a number of games in the second game is set to a predetermined number of games, and the second game is controlled such that the second game is repeated until the number of games in the second game reaches zero, and

the processing (3-5) includes processing (3-5-1) in which when rearranged symbols in the second game satisfy the first condition, the predetermined number of games is added to a number of games in the second game.

By employing the configuration of the above-described aspect of the present invention, the combination of symbols in the first game which causes the game to shift to the second game serves to increase the number of games in the second game. Thus, monotonousness in the second game is avoided and a player is provided with a variety of game patterns.

The gaming machine according to the present invention avoids monotonousness upon executing the free games and realizes a variety of game patterns.

These and other aspects, features and advantages of the present invention will become readily apparent to those having ordinary skill in the art upon a reading of the following detailed description of the invention in view of the drawings and claims.

### BRIEF DESCRIPTION OF THE DRAWINGS

The nature and mode of operation of the present invention will now be more fully described in the following detailed description of the invention taken with the accompanying drawing figures, in which:

FIG. 1 is a view illustrating a function flow of a gaming machine;

FIG. 2 is a view illustrating a game system including gaming machines;

FIG. 3 is a view illustrating the overall configuration of the gaming machine;

FIGS. 4A, 4B, 4C, and 4D are views illustrating tables each showing arrays of symbols depicted on a peripheral surface of each of the reels of the gaming machine in a basic game;

FIGS. 5A, 5B, 5C, and 5D are views illustrating tables each showing arrays of symbols depicted on the peripheral surface of each of the reels of the gaming machine in free games;

FIG. 6 is a block diagram illustrating an internal configuration of the gaming machine;

FIGS. 7A and 7B are views illustrating patterns of winning lines and a winning line definition table for the gaming machine;

FIGS. 8A and 8B are views illustrating a payout table and a symbol definition table for the gaming machine;

FIG. 9 is a view illustrating shifting of the basic game and the free games for the gaming machine;

FIG. 10 is a view illustrating a flowchart of main control processing for the gaming machine;

FIG. 11 is a view illustrating a flowchart of coin-insertion/start-check processing for the gaming machine;

FIG. 12 is a view illustrating a flowchart of jackpot-related processing for the gaming machine;

FIG. 13 is a view illustrating a flowchart of symbol lottery processing for the gaming machine;

FIG. 14 is a view illustrating a flowchart of predictive effect lottery processing for the gaming machine;

FIG. 15 is a view illustrating a predictive effect determination table for the gaming machine;

FIG. 16 is a view illustrating a flowchart of symbol display control processing for the gaming machine;

FIG. 17 is a view illustrating a flowchart of to-be-paid-out number determination processing for the gaming machine;

FIG. 18 is a view illustrating a flowchart of free game processing for the gaming machine;

FIG. 19 is a view illustrating a flowchart of upon-free-game-symbol-lottery processing for the gaming machine;

FIG. 20 is a view illustrating a flowchart of upon-free-game predictive effect lottery processing for the gaming machine;

FIG. 21 is a view illustrating an upon-free-game predictive effect determination table;

FIG. 22 is a view illustrating a flowchart of upon-free-game symbol display control processing for the gaming machine;

FIGS. 23A and 23B are views for illustrating predictive effects;

FIGS. 24A and 24B are views for illustrating predictive effects;

FIGS. 25A and 25B are views for illustrating predictive effects;

FIGS. 26A, 26B, and 26C are views for illustrating effects in upon-free-game symbol display control processing;

FIGS. 27A, 27B, and 27C are views for illustrating a modified example of the effects in the upon-free-game symbol display control processing;

FIGS. 28A, 28B, and 28C are views for illustrating the modified example of the effects in the upon-free-game symbol display control processing;

FIGS. 29A, 29B, and 29C are views for illustrating the modified example of the effects in the upon-free-game symbol display control processing;

FIGS. 30A and 30B are views for illustrating the modified example of the effects in the upon-free-game symbol display control processing;

FIG. 31 is a view illustrating a flowchart of the upon-free-game symbol display control processing related to the modified example; and

FIGS. 32A and 32B are views illustrating the effects in the upon-free-game symbol display control processing related to the modified example.

### DETAILED DESCRIPTION OF THE PREFERRED EMBODIMENT

[Explanation of Function Flow Diagram]

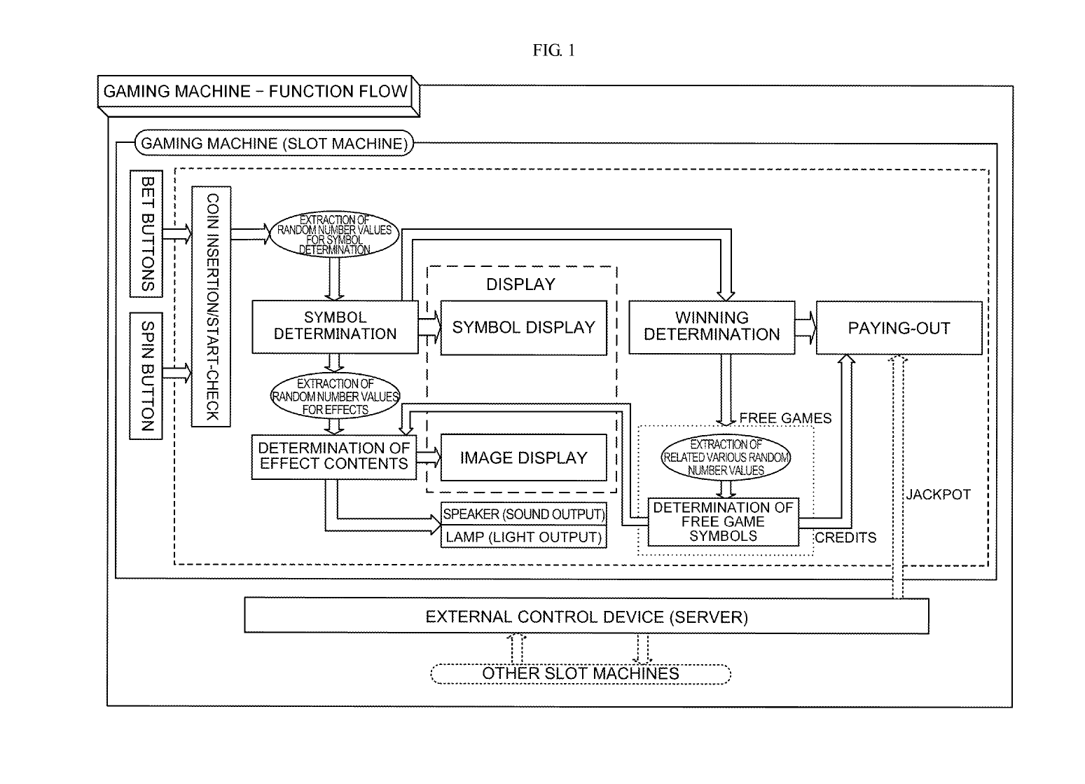

With reference to FIG. 1, basic functions of a gaming machine according to the present embodiment will be described. FIG. 1 is a view illustrating a function flow of the gaming machine according to the embodiment of the present invention.

<Coin-Insertion/Start-Check>

First, the gaming machine checks whether or not a player has inserted coins or that a value on a number-of-credit counter is not zero, and subsequently, the gaming machine checks whether or not any BET button has been pressed by a player. Thereafter, the gaming machine checks whether or not a spin button has been pressed by a player.

<Symbol Determination>

Next, when the spin button has been pressed by a player, the gaming machine extracts random values for symbol determination and determines symbols to be displayed at the time of stopping scrolling of symbol arrays for a player, for a plurality of respective video reels displayed on a display. In said symbol arrays, four consecutive special symbols whose kind is the same are included.

<Symbol Display>

Next, the gaming machine starts scrolling of the symbol array of the respective video reels and then stops the scrolling such that the determined symbols are displayed for a player, thereby rearranging the symbols.

<Winning Determination>

Next, when the scrolling of the symbol array of each video reel has been stopped, the gaming machine determines whether or not a combination of symbols displayed for a player is a combination related to winning.

<Payout>

When the combination of symbols displayed for a player is a combination related to winning, the gaming machine awards a benefit in accordance with the combination to a player. For example, when a combination of symbols related to paying-out of coins has been displayed, the gaming machine pays out the number of coins in accordance with the combination of symbols to a player.

<Free Games>

In addition, when a combination of symbols related to a bonus game trigger is displayed, the gaming machine starts a bonus game. Each of the free games is a game in which a lottery related to the determination of to-be-stopped symbols is conducted without consuming any coins.

In each of the free games, when the spin button is pressed by a player, the gaming machine extracts random number values for determination of upon-free-game symbols and determines symbols to be displayed for a player when scrolling of symbol arrays is stopped, so as to correspond to each of a plurality of video reels which are displayed on the display. Next, when in display regions corresponding to any of the video reels among symbol display regions, four consecutive special symbols whose kind is the same are rearranged and in display regions corresponding to each of the other video reels, one to three special symbols whose kind is the same are rearranged, said other video reels are displayed in an upward direction or a downward direction in a moving manner and thus, four consecutive special symbols whose kind is the same are rearranged. Thereafter, as in the basic game, winning determination and paying-out are conducted.

In addition, in each of the free games, when a combination of symbols related to a free game trigger is further displayed, a number of games is added to a number of free games. When the number of free games reaches zero, the free games is finished and the game returns to the basic game.

In addition, the gaming machine also can executes a jackpot game. In the jackpot game, when a predetermined level is won, a jackpot amount of coins are paid out to a player. Referred to as the jackpot is a function of accumulating a part of coins which are consumed by a player in the gaming machine as the jackpot amount and in a case where a player wins the predetermined level of a jackpot, paying out a payout amount in accordance with a payout of that level. The gaming machine computes the amount which is accumulated as the jackpot amount (accumulated amount) each time one game is played and accumulates the amounts in the jackpot amount.

The jackpot in the gaming machine according to the present invention may be configured as a standalone type such that a single gaming machine is employed and a part of coins consumed in the single gaming machine is accumulated as the jackpot amount in that gaming machine, or alternatively, may be configured as a network type such that a jackpot is shared by connecting other gaming machines (slot machines) to one another in a single gaming facility or in a plurality of gaming facilities, and the accumulated amount of a jackpot is transmitted via an external control device.

In the network type, a part of coins consumed by a player in each gaming machine is transmitted as the amount of a jackpot to the external control device, and in the external control device, the received amount of a jackpot is accumulated and is shared by each gaming machine. In a case where a gaming machine wins the predetermined level of a jackpot, the amount of a jackpot is transmitted from the external control device to that gaming machine.

<Determination of Effects>

The gaming machine conducts effects by displaying images on the display, outputting light from lamps, and outputting sounds from speakers. The gaming machine extracts random number values for the effects and determines contents of the effects based on the symbols and the like determined by lottery. In addition, in each of the free games, contents of the effects are selected in accordance with a situation and the like of each of the free games and said contents of effects are executed.

[Overall Game System]

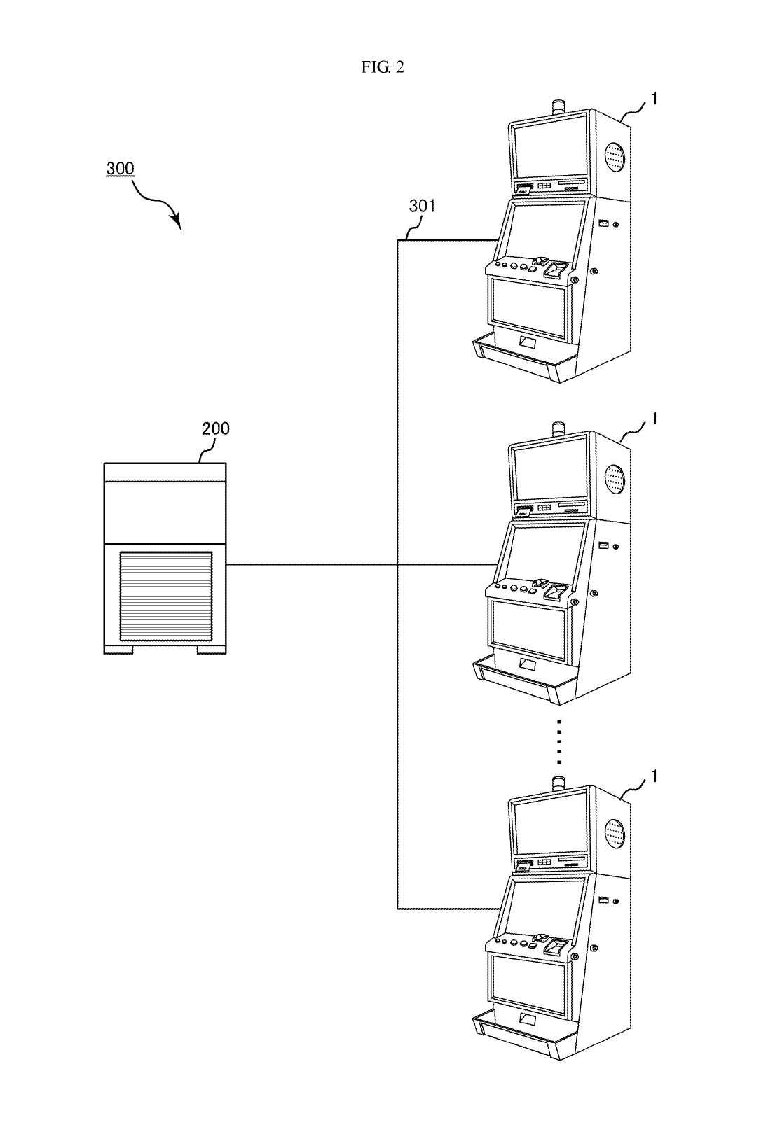

Next, with reference to FIG. 2, a game system including the gaming machine will be described. FIG. 2 is a view illustrating the game system including the gaming machines according to the embodiment of the present invention.

A game system 300 includes a plurality of gaming machines 1 and an external control device 200 which is connected to each of the gaming machines 1 via a communication line 301.

The external control device 200 is for controlling the plurality of gaming machines 1. In the present embodiment, the external control device 200 is the so-called hall server which is installed in a game facility having the plurality of gaming machines 1. Each of the gaming machines 1 is provided with a unique identification number, and the external control device 200 identifies transmission sources of data transmitted from the respective gaming machines 1 by using the identification numbers. Also in the case where the external control device 200 transmits data to a gaming machine 1, the identification numbers are used for specifying the transmission destination.

It is to be noted that the game system 300 may be constructed within a single game facility where various games can be conducted, such as a casino, or may be constructed among a plurality of game facilities. In addition, when the game system 300 is constructed in a single game facility, the game system 300 may be constructed in each floor or section of the game facility. The communication line 301 may be a wired or wireless line, and can adopt a dedicated line, an exchange line or the like.

[Overall Configuration of Gaming Machine]

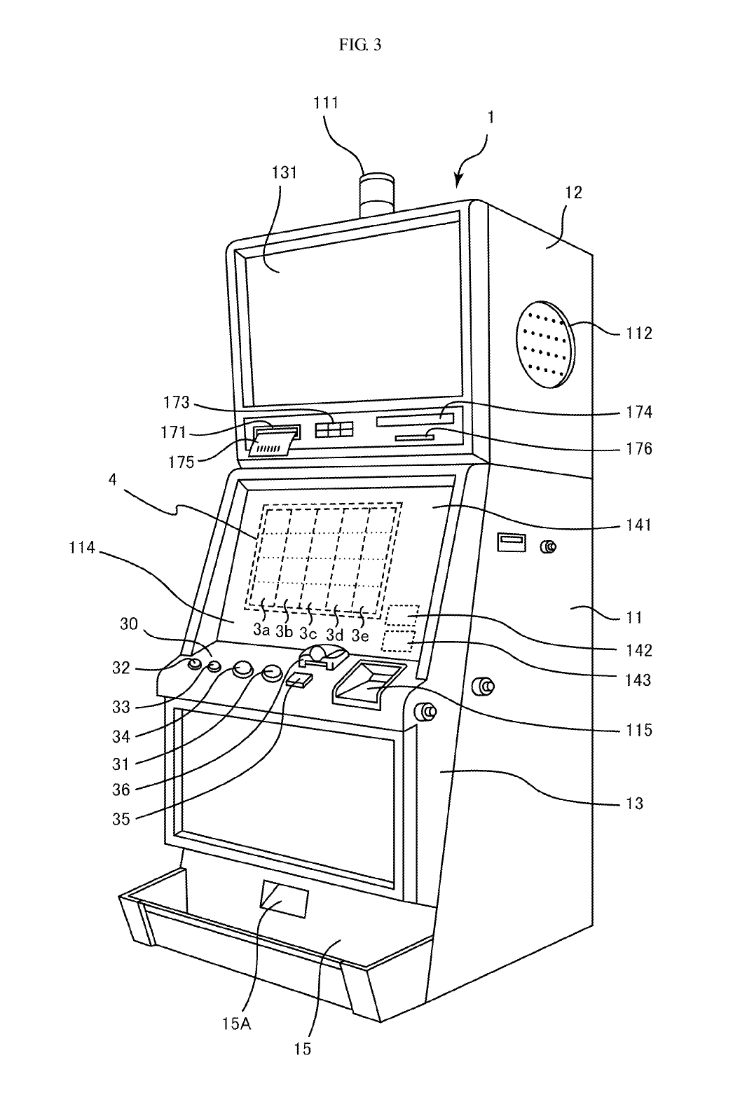

Next, with reference to FIG. 3, an overall configuration of the gaming machine 1 will be described. FIG. 3 is a view illustrating the overall configuration of the gaming machine according to the embodiment of the present invention.

Coins, bills, or electrical valuable information corresponding to these are used as game media in the gaming machine 1. In addition, in the present embodiment, the-later-described ticket with a barcode is also used. It is to be noted that the game media are not limited to these, and for example, medals, a token, electric money, or the like can be adopted.

The gaming machine 1 includes a cabinet 11, a top box 12 installed on the upper side of the cabinet 11, and a main door 13 provided at the front face of the cabinet 11.

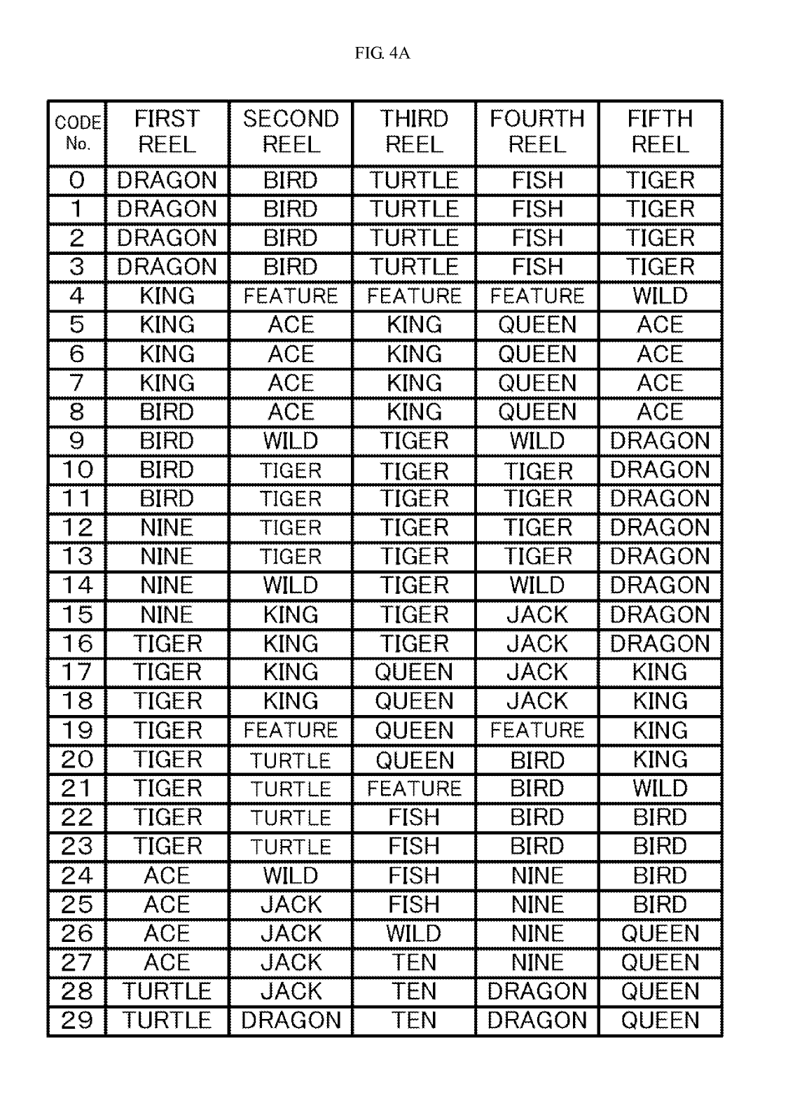

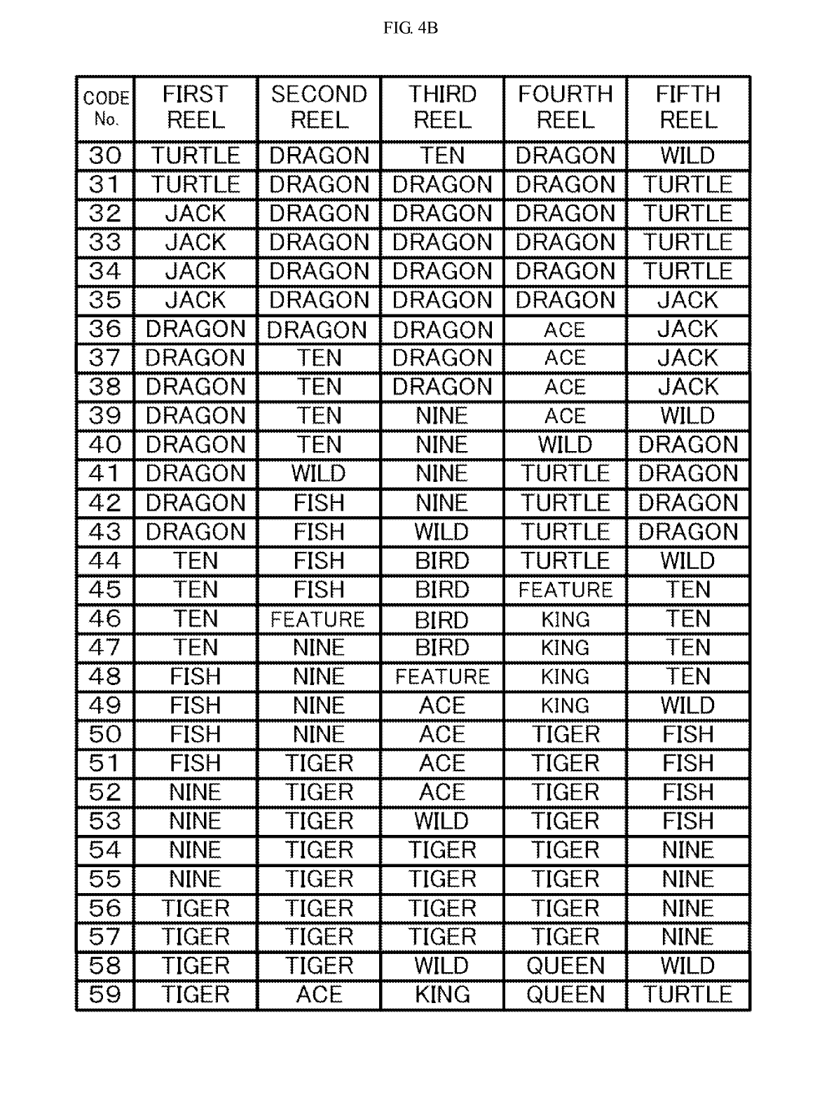

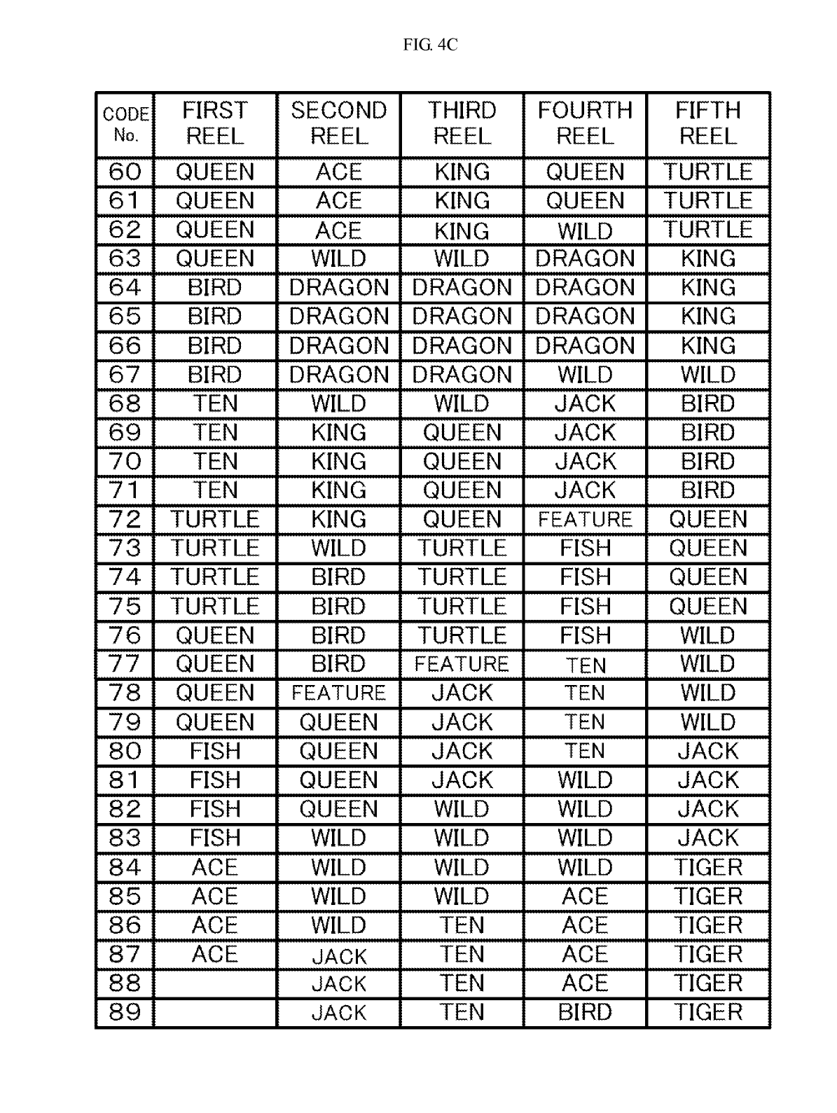

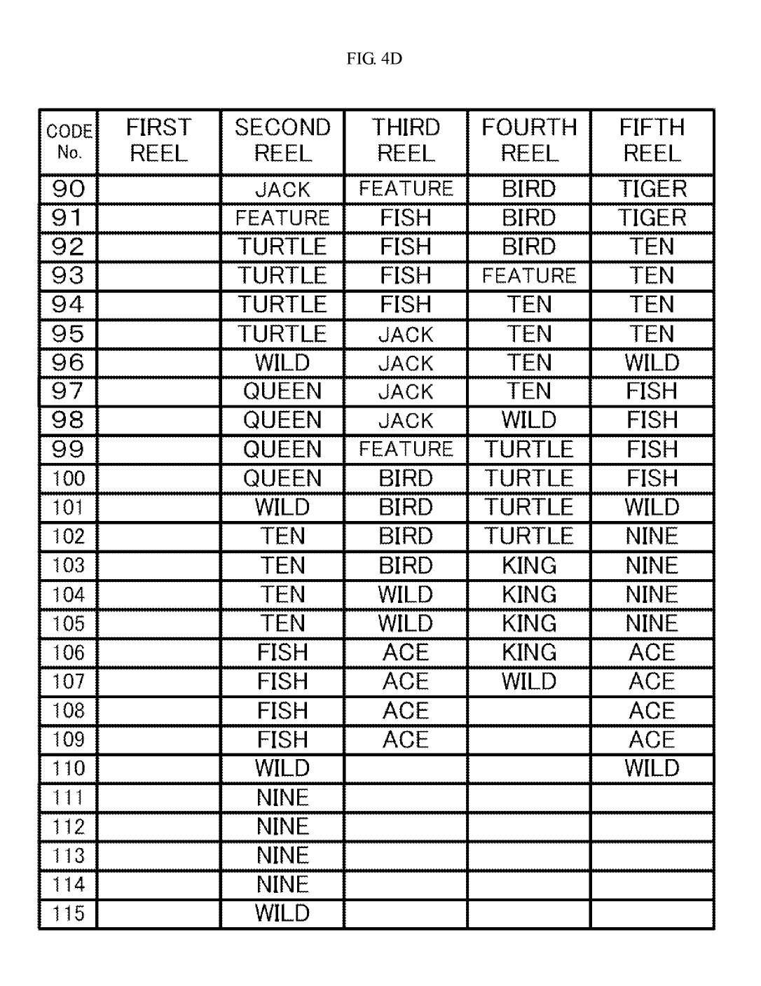

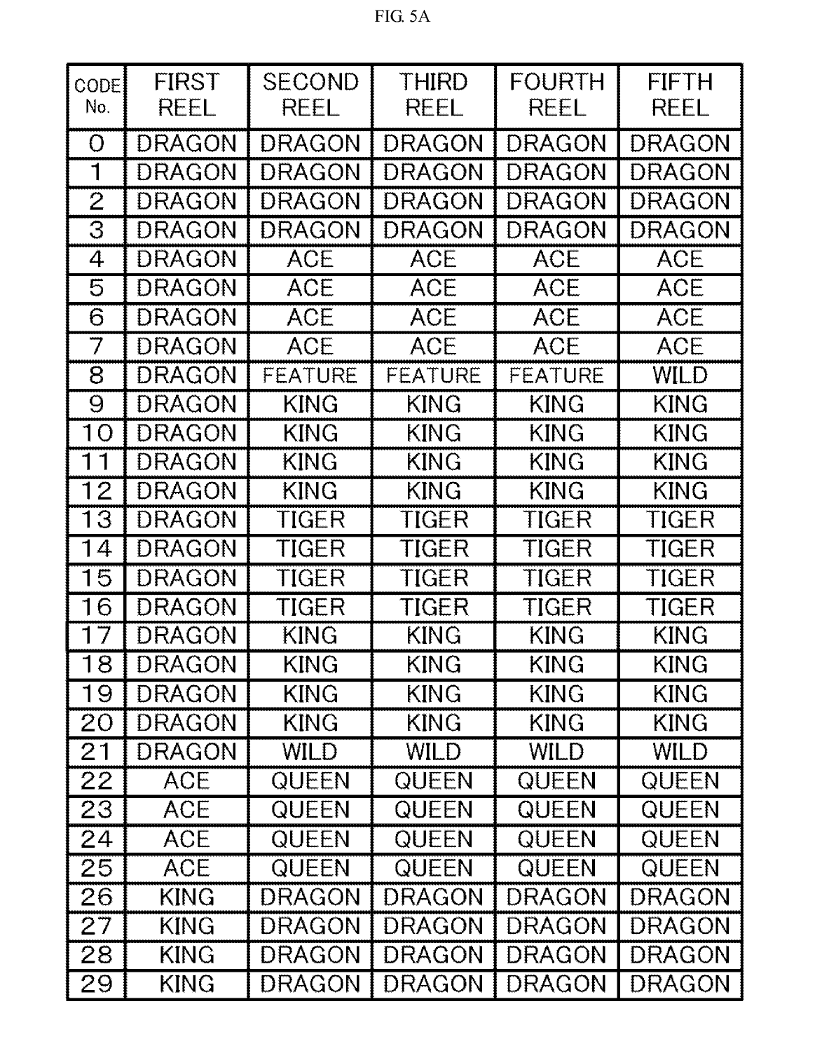

A lower image display panel 141 is provided at the center of the main door 13. The lower image display panel 141 includes a liquid crystal panel and forms the display. The lower image display panel 141 has symbol display regions 4. In the symbol display regions 4, five video reels 3 (3a, 3b, 3c, 3d, and 3e) are displayed. In the present embodiment, each of the video reels is for representing, by images, motions of rotating and stopping of a mechanical reel having a plurality of symbols depicted on the peripheral surface thereof. To each of the video reels 3, a symbol array comprised of a previously determined plurality of symbols is assigned (see FIGS. 4A to 5D described later).

In the symbol display regions 4, the symbol arrays assigned to the respective video reels 3 are respectively scrolled and are stopped after predetermined time has elapsed. As a result, a part (four consecutive symbols in the present embodiment) of each of the symbol arrays is displayed for a player. In the symbol display regions 4, there are four regions, that is, an upper region, an upper central region, a lower central region, and a lower region, for each video reel 3, and a single symbol is to be displayed to each region. That is, 20 (=5 columns×4 symbols) symbols are to be displayed in the symbol display regions 4. In the present embodiment, scrolling of the symbol arrays is stopped in the order of the video reel 3a, the video reel 3b, the video reel 3c, the video reel 3d, and the video reel 3e.

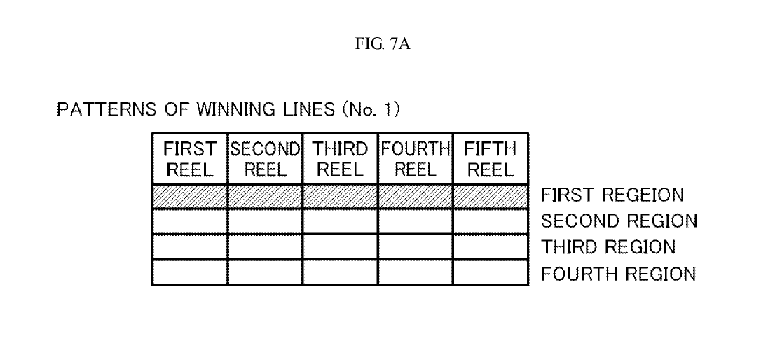

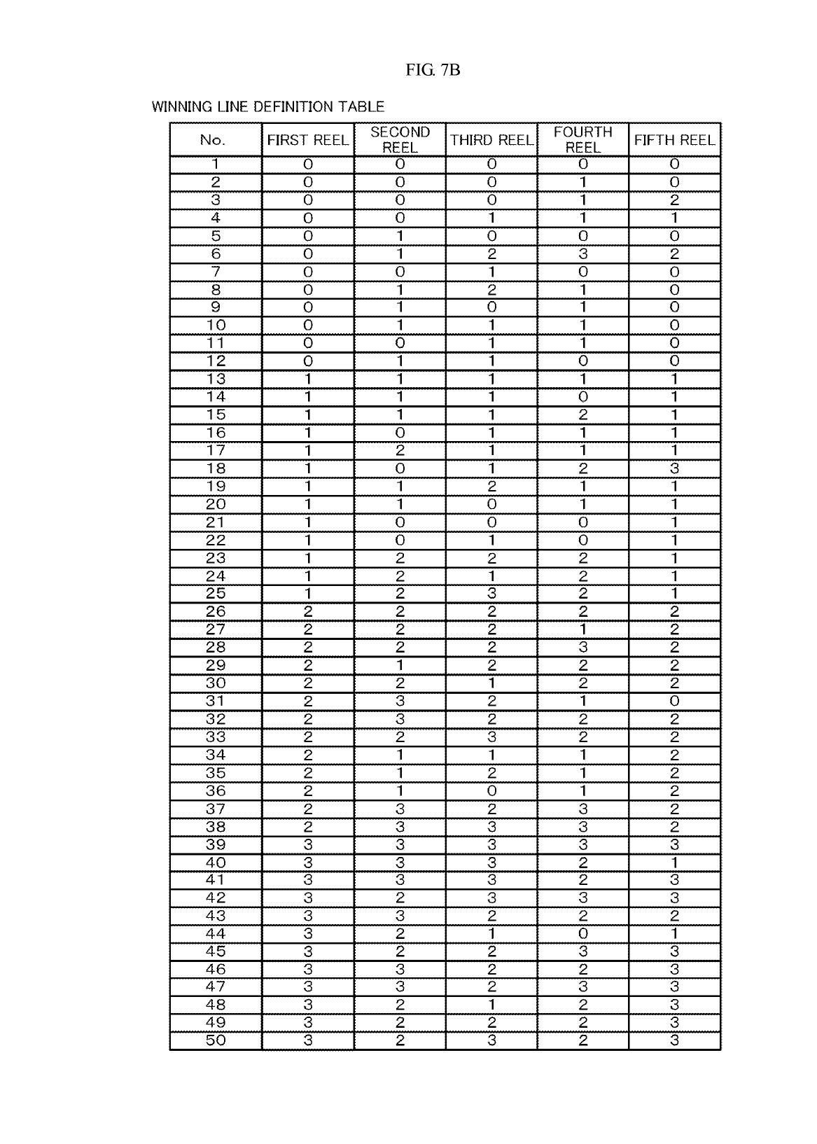

In the present embodiment, a line formed by selecting one of the aforementioned four regions for each of the video reels 3 and connecting the respective regions is referred to as a winning line. It is to be noted that any desired shape of the winning line can be adopted, and examples of the shape of the winning line may include a straight line formed by connecting the upper central regions for the respective video reels 3, a V-shaped line, and a bent line. Also, any desired number of lines can be adopted, and the number can be, for example, 50 lines. One example of the winning lines will be specifically described later with reference to FIG. 7.

In addition, the lower image display panel 141 has a number-of-credit display region 142 and a number-of-payout display region 143. The number-of-credit display region 142 displays the number of coins (hereinafter also referred to as “the number of credits”) owned by a player and retained inside the gaming machine 1. The number-of-payout display region 143 displays the number of coins (hereinafter also referred to as “the number of gaming media to be paid out”) to be paid out to a player when winning is established.

The lower image display panel 141 has a built-in touch panel 114. The player can input various instructions by touching the lower image display panel 141.

On the lower side of the lower image display panel 141, there arranged are various buttons provided in a control panel 30 and various devices to be operated by a player.

A spin button 31 is used when starting scrolling of the symbol arrays of the respective video reels 3. A change button 32 is used when requesting a game facility staff member to exchange money. A CASHOUT button 33 is used when paying out the coins retained inside the gaming machine 1 to a coin tray 15.

A 1-BET button 34 and a maximum BET button 35 are used for determining the number of coins (hereinafter also referred to as “the number of BETs”) to be used in the game from the coins retained inside the gaming machine 1. The 1-BET button 34 is used when determining one coin at a time for the aforementioned number of BETs. The maximum BET button 35 is used when setting the aforementioned number of BETs to a defined upper limit number.

A coin accepting slot 36 is provided to accept coins. A bill validator 115 is provided to accept bills. The bill validator 115 validates a bill and accepts a valid bill into the cabinet 11. It is to be noted that the bill validator 115 may be configured so as to be capable of reading the later-described ticket 175 with a barcode.

An upper image display panel 131 is provided at the front face of the top box 12. The upper image display panel 131 includes a liquid crystal panel and forms the display. On the upper image display panel 131, displayed are images related to effects, a WIN signboard related to the later-described free games (a display part showing the occurrence of winning, a number of obtained credits, and the like as the effects) and images showing introduction of the game contents and explanation of the game rules. In addition, the top box 12 is provided with a speaker 112 and a lamp 111. The gaming machine 1 conducts effects by displaying images onto the lower image display panel 141 and the upper image display panel 131, outputting sounds, and outputting the light.

A ticket printer 171, a card slot 176, a data display 174, and a keypad 173 are provided on the lower side of the upper image display panel 131.

The ticket printer 171 prints on a ticket a barcode representing encoded data of the number of credits, date, the identification number of the gaming machine 1, and the like and outputs the ticket as the ticket 175 with a barcode. The player can make a gaming machine read the ticket 175 with a barcode so as to play a game thereon, and can also exchange the ticket 175 with a barcode with a bill or the like at a predetermined place (for example, a cashier in a casino) in the game facility.

The card slot 176 is for inserting a card in which predetermined data is stored. For example, the card stores data for identifying a player and data about the history of games played by a player. When the card is inserted into the card slot 176, the later-described card reader 172 reads data from the card or writes data into the card. It is to be noted that the card may store data corresponding to a coin, a bill or a credit.

The data display 174 includes a fluorescent display, LEDs and the like and displays the data read by the card reader 172 or the data inputted by a player via the keypad 173, for example. The keypad 173 is for inputting an instruction and data related to ticket issuance or the like.

Here, the gaming machine according to the embodiment of the present invention controls the displaying of the video reels on the display. However, the gaming machine may be of a type which displays symbols to a player through driving mechanical reels by a stepping motor or the like. In addition, in the present specification, in order to describe the technical ideas of the present invention, the gaming machine 1 having the aforementioned configuration is described as one example. However, the present invention is not limited thereto. The present invention can be realized by gaming machines having other various configurations.

[Symbol Arrays of Video Reels]

Next, with reference to FIGS. 4A to 5D, a configuration of the symbol arrays which the video reels 3 of the gaming machine 1 have will be described. FIGS. 4A to 4D are views illustrating tables each showing the arrays of symbols depicted on a peripheral surface of each of the reels in the basic game for the gaming machine according to the embodiment of the present invention. FIGS. 5A to 5D are views illustrating tables each showing arrays of symbols depicted on the peripheral surface of each of the reels in the free games for the gaming machine according to the embodiment of the present invention.

In the symbol arrays related to the basic game shown in FIGS. 4A to 4D, a symbol array comprised of 88 symbols which correspond to code numbers=0 to 87 is assigned to the first reel (first video reel 3a); a symbol array comprised of 116 symbols which correspond to code numbers=0 to 115 is assigned to the second reel (second video reel 3b); a symbol array comprised of 109 symbols which correspond to code numbers=0 to 108 is assigned to the third reel (third video reel 3c); a symbol array comprised of 108 symbols which correspond to code numbers=0 to 107 is assigned to the fourth reel (fourth video reel 3d); and a symbol array comprised of 111 symbols which correspond to code numbers=0 to 110 is assigned to the fifth reel (fifth video reel 3e).

As kinds of symbols, “WILD”, “DRAGON”, “TIGER”, “BIRD”, “TURTLE”, “FISH”, “ACE”, “KING”, “QUEEN”, “JACK”, “TEN”, “NINE”, and “FEATURE” are provided, and symbols which respectively correspond to these are displayed on the video reels. Here, the “WILD” symbol functions as a wildcard and is a substitute symbol for a symbol required in the determination of a winning combination on a winning line. The “DRAGON” and “TIGER” symbols are top symbols whose payouts are the highest. In addition, as for the “FEATURE” symbol, irrespective of any winning line, when a predetermined number of “FEATURE” symbols are displayed in the symbol display regions 4 comprised of 20 symbols (=5 columns×4 symbols), a predetermined benefit is provided for a player.

In the gaming machine according to the embodiment of the present invention, the symbol arrays displayed on the video reels in the basic game are different from those displayed on the video reels in the free games. The symbol arrays shown in FIGS. 5A to 5D are the symbol arrays in the free games and are configured so as to be different from the symbol arrays in the basic game shown in FIGS. 4A to 4D. Here, a symbol array comprised of 92 symbols which correspond to code numbers=0 to 91 is assigned the first reel (first video reel 3a); a symbol array comprised of 94 symbols which correspond to code numbers=0 to 93 is assigned to the second reel (second video reel 3b); a symbol array comprised of 94 symbols which correspond to code numbers=0 to 93 is assigned to the third reel (third video reel 3c); a symbol array comprised of 94 symbols which correspond to code numbers=0 to 93 is assigned to the fourth reel (fourth video reel 3d); and a symbol array comprised of 94 symbols which correspond to code numbers=0 to 93 is assigned to the fifth reel (fifth video reel 3e).

As described above, the symbol arrays related to the free games shown in FIGS. 5A to 5D are different from the symbol arrays related to the basic game shown in FIGS. 4A to 4D. The symbol arrays related to the free games are set such that the number of symbols of which each of the symbol arrays of all of the video reels is comprised is small and the numbers (ratios) of the “DRAGON” and “TIGER” symbols which are the top symbols are large.

[Configuration of Circuit Included in Gaming Machine]

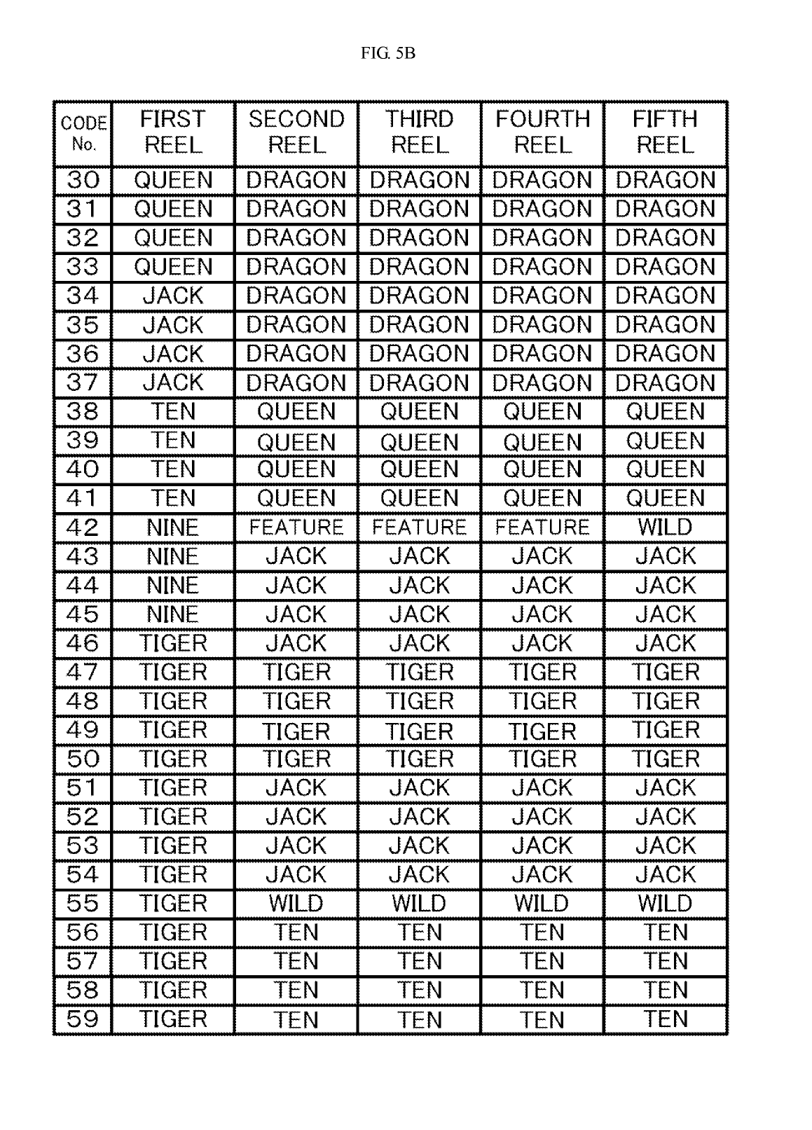

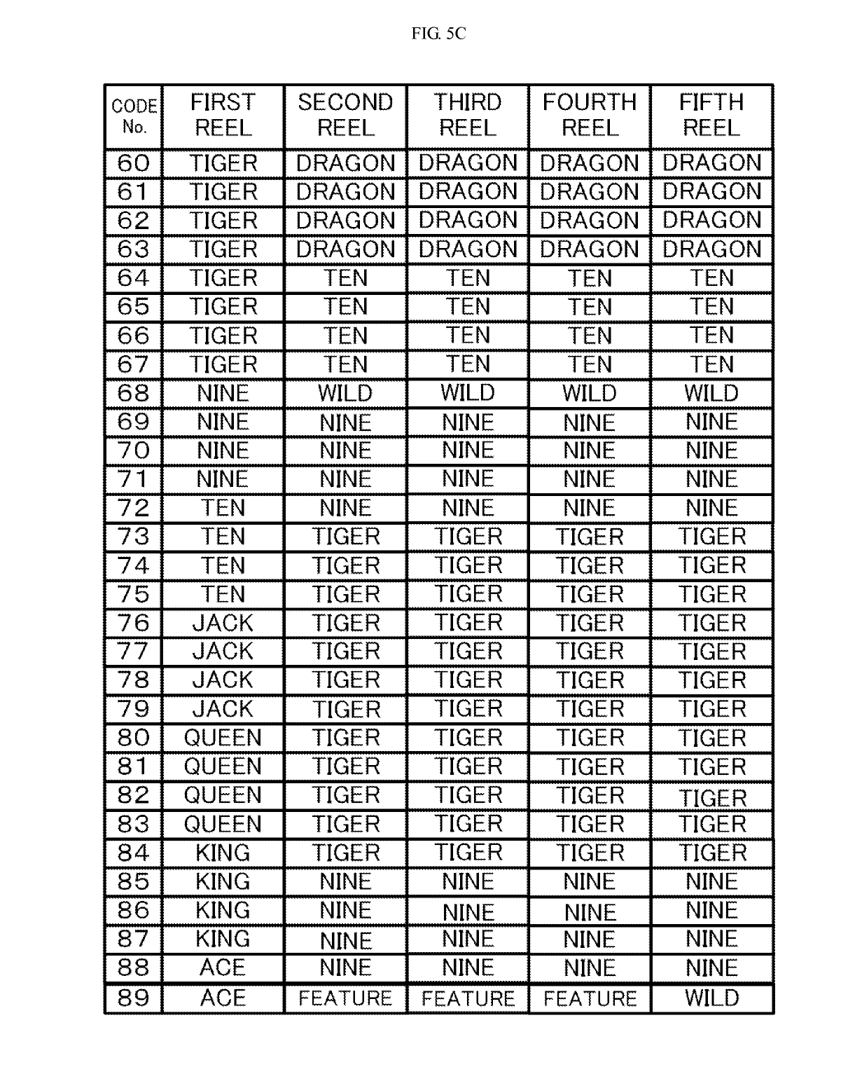

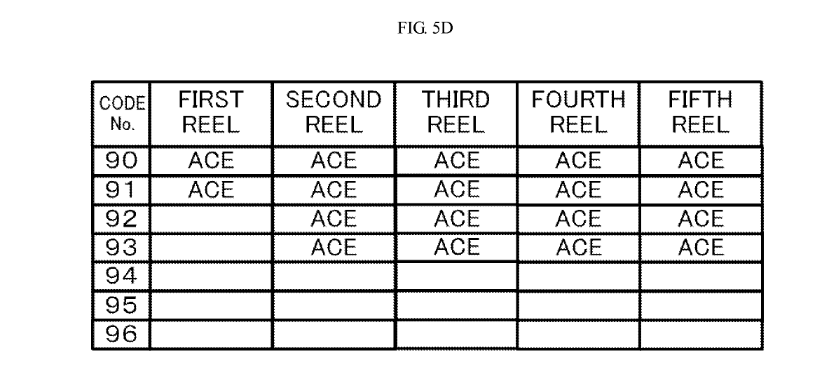

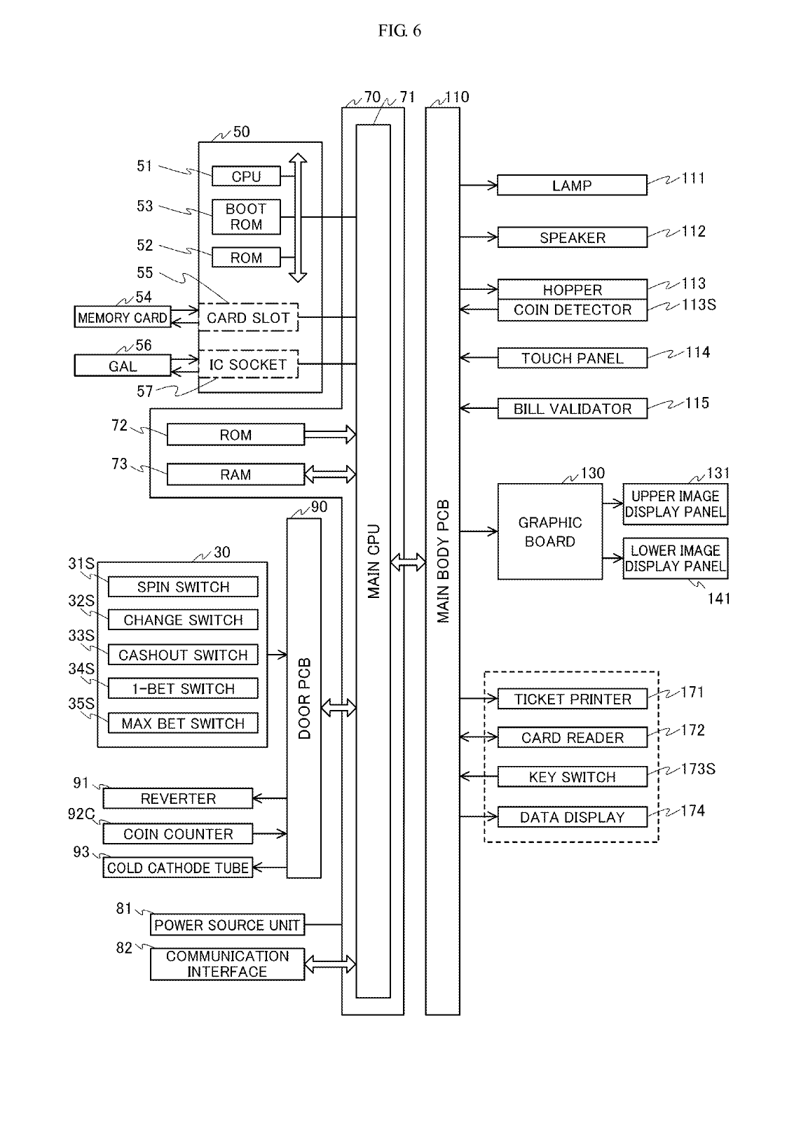

Next, with reference to FIG. 6, a configuration of a circuit included in the gaming machine 1 will be described. FIG. 6 is a block diagram illustrating an internal configuration of the gaming machine according to the embodiment of the present invention.

A gaming board 50 is provided with: a CPU 51, a ROM 52, and a boot ROM 53, which are mutually connected by an internal bus; a card slot 55 corresponding to a memory card 54; and an IC socket 57 corresponding to a GAL (Generic Array Logic) 56.

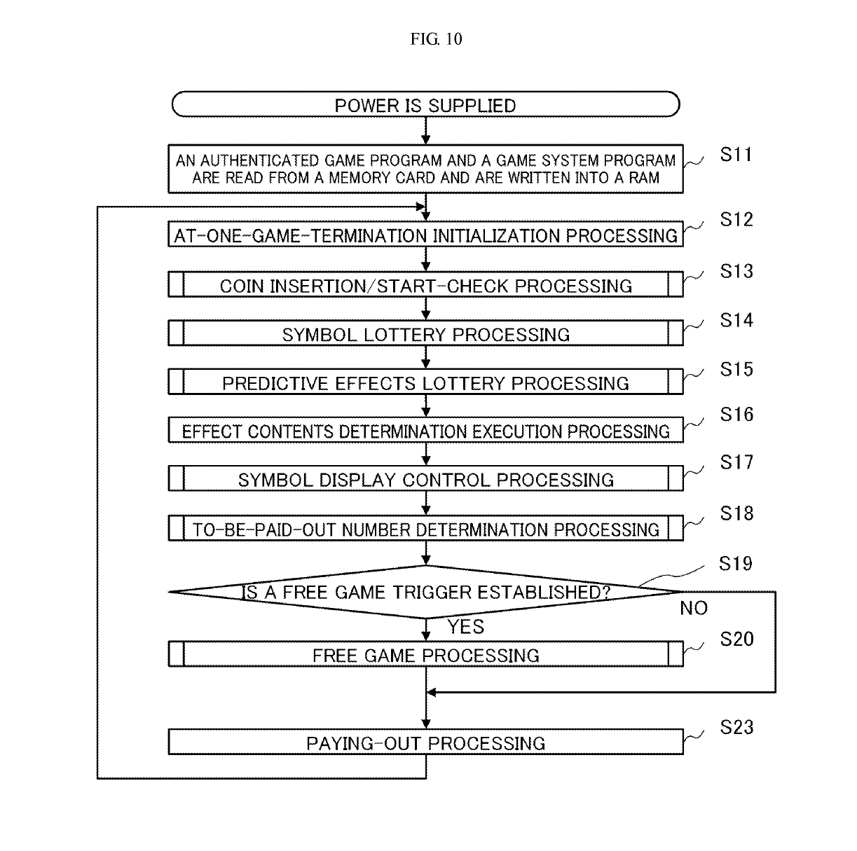

The memory card 54 includes a non-volatile memory, and stores a game program and a game system program. The game program includes a program related to game progression, a lottery program, and a program for conducting effects by images and sounds (for example, see FIGS. 10 to 14, FIGS. 16 to 20, FIG. 22, and FIG. 31 which are described later). In addition, the aforementioned game program includes data (see FIGS. 4A to 5D) specifying the configuration of the symbol array assigned to each video reel 3.

The lottery program is a program for determining to-be-stopped symbols of each video reel 3 by lottery. The to-be-stopped symbols are data for determining four symbols to be displayed in the symbol display region four out of the 22 symbols forming each symbol array. The gaming machine 1 of the present embodiment determines as the to-be-stopped symbols the symbols to be displayed in a predetermined region (for example, the upper region) out of the four regions provided for each of the video reels 3 of the symbol display regions 4.

The aforementioned lottery program includes symbol determination data. The symbol determination data is data which specifies random number values such that each of the plurality of symbols forming the symbol array is determined at an equal probability, for each video reel 3. The probabilities of the respective symbols being determined are basically equal. However, as shown in FIGS. 4A to 5D, since the numbers of kinds of symbols included in the plurality of symbols are different from one another, the probabilities of the kinds of symbols being determined are different from one another (i.e. different weights on the probabilities are generated). For example, with reference to FIGS. 4A to 4D, in the symbol array of the first reel (first vide reel 3a), whereas 8 “ACE” symbols are included, 12 “TIGER” symbols are included. Therefore, the former is determined at the probability of “8/88”, whereas the latter is determined at the probability of “12/88”. In addition, in accordance with the kinds of symbols, combinations, and positions of the symbols (code numbers), different winning probabilities can also be set.

It is to be noted that, although the data specifies that the different numbers of symbols be provided to form the symbol arrays of the respective video reels 3 in the present embodiment, equal numbers of symbols may form the respective video reels 3. For example, the symbol array of each of the first reel (first video reel 3a) to the fifth reel (fifth video reel 3e) may consist of 20 symbols.

In addition, the card slot 55 is configured so that the memory card 54 can be inserted thereinto and removed therefrom, and is connected to a motherboard 70 by an IDE bus.

The GAL 56 is a type of PLD (Programmable Logic Device) having a fixed OR array structure. The GAL 56 is provided with a plurality of input ports and output ports, and predetermined input into the input port causes output of the corresponding data from the output port.

In addition, the IC socket 57 is configured so that the GAL 56 can be inserted thereinto and removed therefrom, and is connected to the motherboard 70 by a PCI bus. The contents of the game to be played on the gaming machine 1 can be changed by replacing the memory card 54 with another memory card 54 having another program written therein or by rewriting the program written into the memory card 54 as another program.

The CPU 51, the ROM 52 and the boot ROM 53 mutually connected by the internal bus are connected to the motherboard 70 by a PCI bus. The PCI bus enables a signal transmission between the motherboard 70 and the gaming board 50 and power supply from the motherboard 70 to the gaming board 50.

The ROM 52 stores an authentication program. The boot ROM 53 stores a pre-authentication program, a program (boot code) to be used by the CPU 51 for activating the pre-authentication program, and the like. The authentication program is a program (tamper check program) for authenticating the game program and the game system program. The pre-authentication program is a program for authenticating the aforementioned authentication program. The authentication program and the pre-authentication program are written along a procedure (authentication procedure) for proving that the program to be the subject has not been tampered.

The motherboard 70 is provided with a main CPU 71, a ROM 72, a RAM 73, and a communication interface 82.

The ROM 72 includes a memory device such as a flash memory, and stores a program such as BIOS to be executed by the main CPU 71, and permanent data. When the BIOS is executed by the main CPU 71, processing for initializing predetermined peripheral devices is conducted; further, through the gaming board 50, processing of loading the game program and the game system program stored in the memory card 54 is started.

The RAM 73 stores data and programs which are used in operation of the main CPU 71. For example, when the processing of loading the aforementioned game program, game system program or authentication program is conducted, the RAM 73 can store the program. The RAM 73 is provided with working areas used for operations in execution of these programs. Examples of the areas include: an area that stores the number of games, the number of BETs, the number of gaming media to be paid out, the number of credits, and the like; and an area that stores symbols (code numbers) determined by lottery.

The communication interface 82 is for communicating with the external control device 200 such as a server, through the communication line 301. In addition, the motherboard 70 is connected with a later-described door PCB (Printed Circuit Board) 90 and a body PCB 110 by respective USBs. The motherboard 70 is also connected with a power supply unit 81. When the power is supplied from the power supply unit 81 to the motherboard 70, the main CPU 71 of the motherboard 70 is activated, and then the power is supplied to the gaming board 50 through the PCI bus so as to activate the CPU 51.

The door PCB 90 and the body PCB 110 are connected with input devices such as a switch and a sensor, and peripheral devices the operations of which are controlled by the main CPU 71. The door PCB 90 is connected with a control panel 30, a reverter 91, a coin counter 92C and a cold cathode tube 93.

The control panel 30 is provided with a spin switch 31S, a change switch 32S, a CASHOUT switch 33S, a 1-BET switch 34S and a maximum BET switch 35S which correspond to the aforementioned respective buttons. Each of the switches outputs a signal to the main CPU 71 upon detection of press of the button corresponding thereto by a player.

The coin counter 92C validates a coin inserted into the coin accepting slot 36 based on its material, shape and the like, and outputs a signal to the main CPU 71 upon detection of a valid coin. Invalid coins are discharged from a coin payout exit 15A.

The reverter 91 operates based on a control signal outputted from the main CPU 71, and distributes valid coins validated by the coin counter 92C into a hopper 113 or a cash box (not illustrated). That is, coins are distributed into the hopper 113 when the hopper 113 is not filled with coins, while coins are distributed into the cash box when the hopper 113 is filled with coins.

The cold cathode tube 93 functions as a backlight installed on the rear face sides of the upper image display panel 131 and the lower image display panel 141, and lights up based on a control signal outputted from the main CPU 71.

The body PCB 110 is connected with the lamp 111, the speaker 112, the hopper 113, a coin detecting portion 113S, the touch panel 114, the bill validator 115, a graphic board 130, the ticket printer 171, the card reader 172, a key switch 173S and the data display 174.

The lamp 111 lights up based on a control signal outputted from the main CPU 71. The speaker 112 outputs sounds such as SE (Sound Effect) and BGM, based on a control signal outputted from the main CPU 71.

The hopper 113 operates based on a control signal outputted from the main CPU 71, and pays out the specified number of coins from the coin payout exit 15A to the coin tray 15. The coin detecting portion 113S outputs a signal to the main CPU 71 upon detection of coins paid out by the hopper 113.

The touch panel 114 detects a place on the lower image display panel touched by a player's finger or the like, and outputs to the main CPU 71 a signal corresponding to the detected place. In addition, similarly, the upper image display panel 131 can be configured as a touch panel. Upon acceptance of a valid bill, the bill validator 115 outputs to the main CPU 71 a signal corresponding to the face amount of the bill.

The graphic board 130 controls display of images conducted by the respective upper image display panel 131 and lower image display panel 141, based on a control signal outputted from the main CPU 71. The symbol display region 4 of the lower image display panel 141 displays the five video reels 3 by which the scrolling and stop motions of the symbol arrays included in the respective video reels 3 are displayed. The number-of-credit display region 142 of the lower image display panel 141 displays the number of credits stored in the RAM 73. The number-of-payout display region 143 of the lower image display panel 141 displays the number of coins to be paid out.

The graphic board 130 is provided with the VDP (Video Display Processor) generating image data based on a control signal outputted from the main CPU 71, the video RAM temporarily storing the image data generated by the VDP, and the like. It is to be noted that the image data used in generation of image data by the VDP is included in the game program that has been read from the memory card 54 and stored into the RAM 73.

Based on a control signal outputted from the main CPU 71, the ticket printer 171 prints on a ticket a barcode representing encoded data of the number of credits stored in the RAM 73, date, the identification number of the gaming machine 1, and the like, and then outputs the ticket as the ticket 175 with a barcode.

The card reader 172 reads data stored in a card inserted into the card slot 176 and transmits the data to the main CPU 71, or writes data into the card based on a control signal outputted from the main CPU 71.

The key switch 173S is provided in the keypad 173, and outputs a predetermined signal to the main CPU 71 when the keypad 173 has been operated by a player.

The data display 174 displays data read by the card reader 172 and data inputted by a player through the keypad 173, based on a control signal outputted from the main CPU 71.

[Pattern of Winning Line]

Next, with reference to FIG. 7A, winning lines in the free games will be described. FIG. 7A shows a winning line of a pattern 1. This winning line is a line formed by connecting a first region of the first reel (first video reel 3a), a first region of the second reel (second video reel 3b), a first region of the f third reel (third video reel 3c), a first region of the fourth reel (fourth video reel 3d), and a first region of the fifth reel (fifth video reel 3e).

Here, when the first region of each of the reels is defined as “0”, a second region of each of the reels is defined as “1”, a third region is defined as “2”, and a fourth region is defined as “3”, 50 lines which are set in the embodiment of the present invention are indicated as in a winning line definition table shown in FIG. 7B. For example, the pattern 1 shown in FIG. 7A is indicated such that all regions of the first reel to the fifth reel are defined as “0”. In a pattern 2, regions of the first reel to the third reel and the fifth reel are defined as “0” and a region of the fourth reel is defined as “1”.

It is to be noted that although the winning line definition table related to the free games are described here, similarly, winning lines related to the basic game are set. In addition, patterns and a number of patterns of the winning lines can be defined so as to be different from those related to the free games.

[Setup of Payout Table]

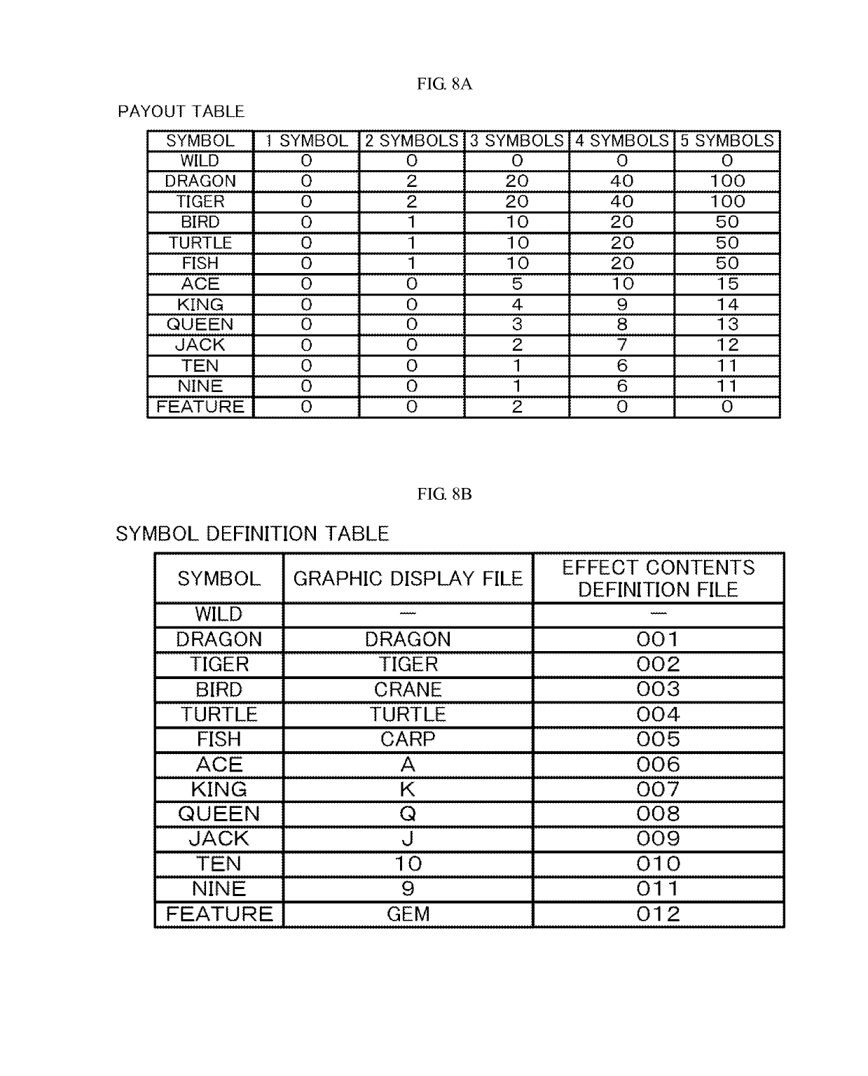

Next, with reference to FIG. 8A, a payout table which defines payouts in the free games will be described. In the embodiment of the present invention, a payout is determined depending on how many symbols whose kind is the same are displayed on each of the respective lines defined in the winning line definition table shown in FIG. 7B. A payout determined as mentioned above is multiplied by the number of BETs specified by a player, and the resultant is added to a number-of-payout counter as a number of gaming media to be paid out.

For example, when two “DRAGON” symbols are on any winning line, a winning (prize win) is established and a payout is “two”, and when five “DRAGON” symbols are on any winning line, a winning whose payout is “100” is established. It is likely that two “DRAGON” symbols and three “BIRD” symbols are on one winning line. In this case, with respect to that winning line, two winnings are simultaneously established and a payout is “12” calculated by adding payouts corresponding to these winnings

As described above, a winning with respect to one winning line is determined, and with respect to 50 winning lines set in the symbol display regions 4 composed of 20 symbols, that is, 5 columns×4 symbols, the above-mentioned determination is conducted. Accordingly, it is likely that a plurality of winnings with respect to one winning line are established and further, with respect to the plurality of winning lines, respective winnings are established.

It is to be noted that although the payout table and the winning determination related to the free games are described here, a payout table related to the f basic game is set and similar winning determination is conducted. In addition, the payout table and a method of the winning determination related to the basic game can be set so as to be different from those related to the free games.

[Setup of Symbol Definition Table]

Next, with reference to FIG. 8B, a symbol definition table which defines graphic display of the symbols and effect contents in the free games will be described. In the embodiment of the present invention, the respective symbols to be displayed in the symbol arrays of the respective video reels 3 are displayed in accordance with the contents of a corresponding graphic display file, defined in the symbol definition table. For example, with respect to the “DRAGON” symbol, a “dragon” is used as a graphic display file and a picture of a dragon is displayed; with respect to the “TIGER” symbol, a “tiger” is used as a graphic display file and a picture of a tiger is displayed; and with respect to the “JACK” symbol, “J” is used as a graphic display file and a shape of a text “J” is displayed. The data defined as the graphic display files corresponding to the respective symbols indicates each image data name used for displaying that symbol, each name of a folder having said image data stored therein, and the like. The display of the symbols may be conducted by using a still picture as well as a moving picture (animation). In this example, the symbols of the “dragon”, the “tiger”, the “crane”, the “turtle”, the “carp”, and the like are picture symbols which are displayed through the animation on predetermined conditions.

An effect contents definition file of the symbol definition table shows a name of data which defines effect contents related to a corresponding symbol and a name of a folder having stored therein a file and the like which define said effect contents.

As described later, when the animation display or the like is conducted in one region in which the plurality of symbol display regions are connected, a graphic display file and an effect contents definition file in accordance with the connected regions are prepared. For example, an individual graphic display file and an effect contents definition file can be associated with each of: a single body symbol displayed in a normal one display region; two consecutive symbols displayed in a region in which two display regions are connected; three consecutive symbols displayed in a region in which three display regions are connected; and four consecutive symbols displayed in a region in which four display regions are connected.

[Game Flow]

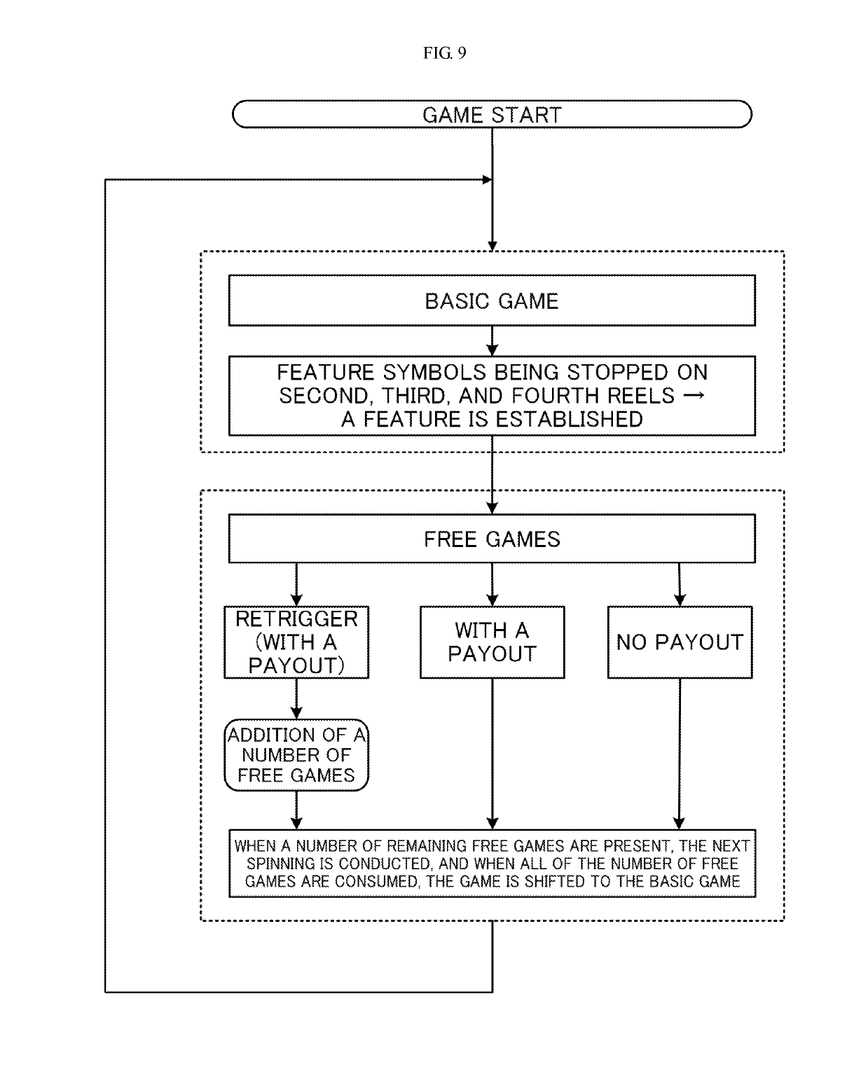

Next, with reference to FIG. 9, a game flow executed by the gaming machine according to the embodiment of the present invention will be described. First, a player inserts coins, presses a BET button, and thereafter, presses a spin button to start a game, whereby a basic game is started. In the basic game, in response to the pressing-down of the spin button by a player, symbols are determined, and scrolling of symbol arrays is stopped such that the determined symbols are displayed to a player.

In the basic game, on the respective video reels 3, the symbol arrays for the basic game are set. For example, displayed are each image of a “dragon” corresponding to a “DRAGON” symbol, each image of a “tiger” corresponding to a “TIGER” symbol, each image of a “crane” corresponding to a “BIRD” symbol, each image of a “turtle” corresponding to a “TURTLE” symbol, and each image of a “carp” corresponding to a “FISH” symbol, and in addition thereto, displayed are images respectively corresponding to an “ACE” symbol, a “KING” symbol, a “QUEEN” symbol, a “JACK” symbol, a “TEN” symbol, a “NINE” symbol, and a “FEATURE” symbol.

Here, when the “FEATURE” symbols are displayed on the second, third, and fourth reels in a stopped manner, a feature is established and free games are started. In the free games, the symbol arrays for the free games are used.

In the free games, a player can play eight free games without inserting new coins (without consuming any credits). Also in the free games, as in the basic game, a payout is determined from symbols which are displayed in the stopped manner and a winning line, a number of gaming media to be paid out, related to a winning combination, is calculated from said determined payout and the number of BETs.

When during the free games, the “FEATURE” symbols are further displayed on the second, third, and fourth reels in the stopped manner, eight free games are added (retrigger). When the number of remaining free games reaches zero, the free games are finished, and the game returns to the basic game.

[Contents of Program]

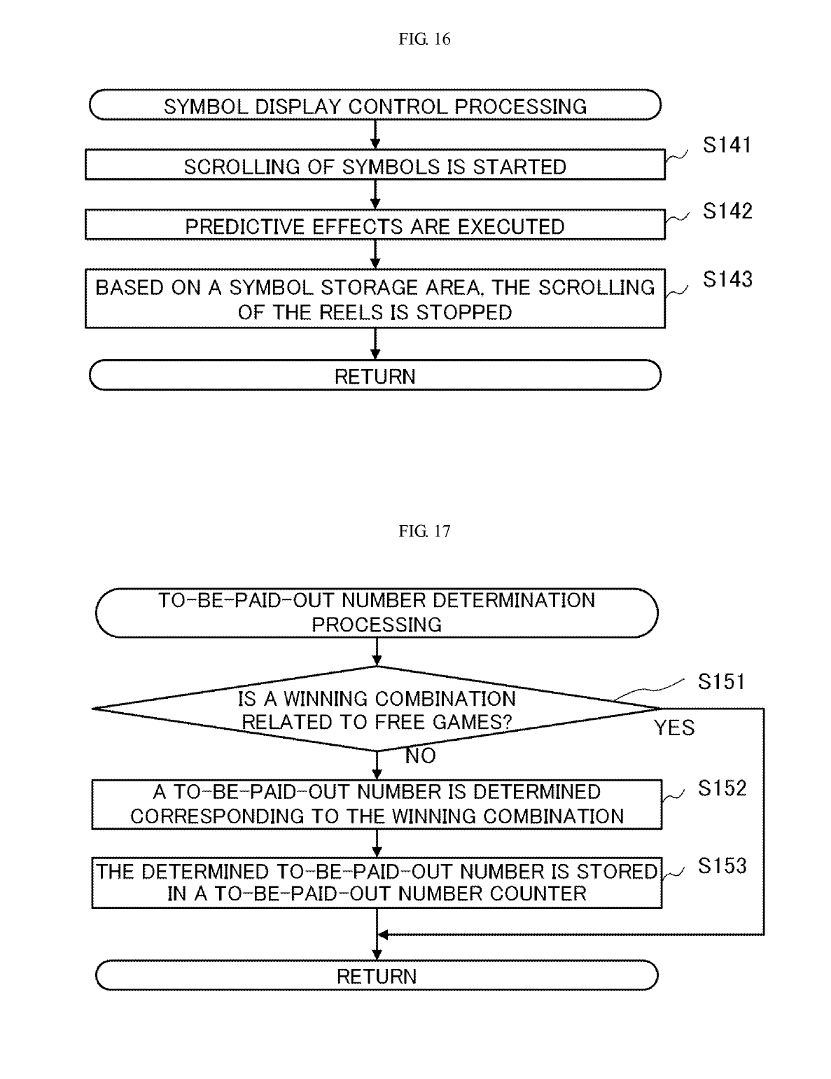

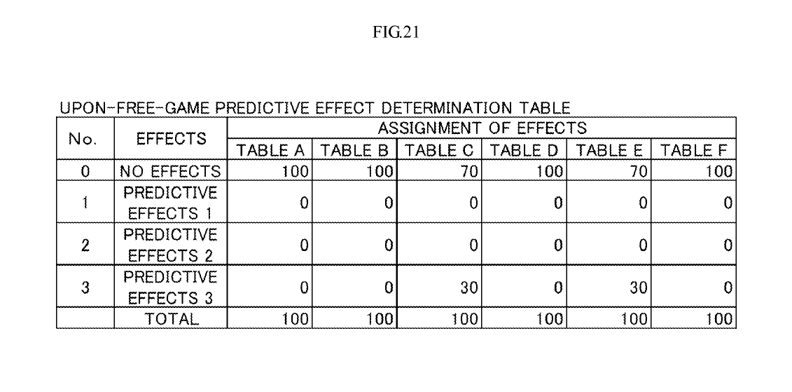

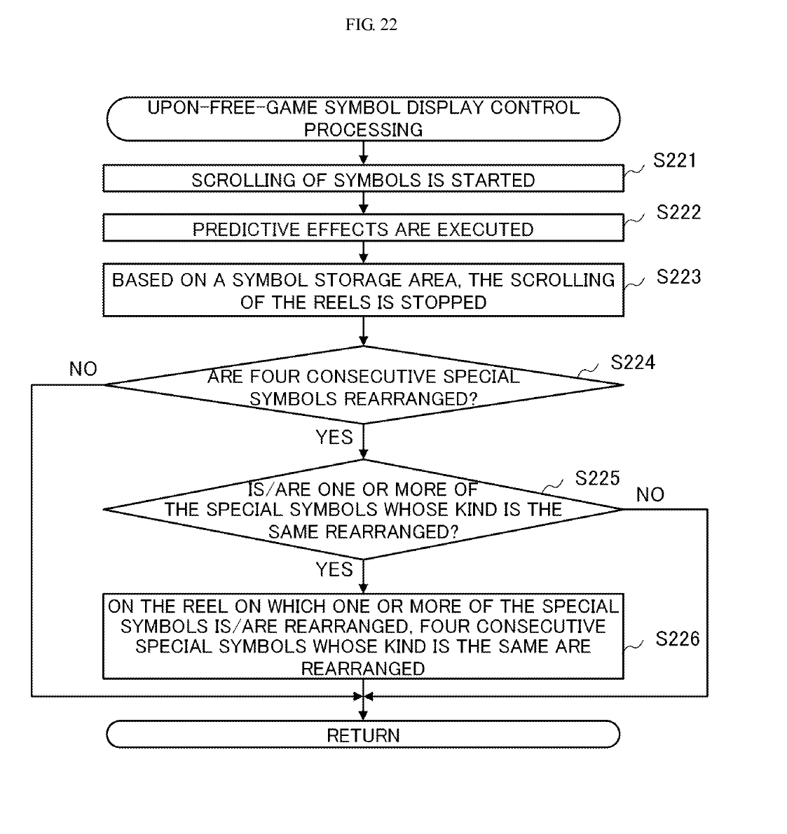

Next, with reference to FIG. 10 to FIG. 14, FIG. 16 to FIG. 20, and FIG. 22, the programs to be executed by the gaming machine 1 will be described.

<Main Control Processing>

First, with reference to FIG. 10, main control processing will be described. FIG. 10 is a view illustrating a flowchart of the main control processing for the gaming machine according to the embodiment of the present invention.

First, when the power is supplied to the gaming machine 1, the main CPU 71 reads the authenticated game program and game system program from the memory card 54 through the gaming board 50, and writes the programs into the RAM 73 (step S11).

Next, the main CPU 71 conducts at-one-game-end initialization processing (step S12). For example, data that becomes unnecessary after each game in the working areas of the RAM 73, such as the number of BETs and the symbols determined by lottery, is cleared.

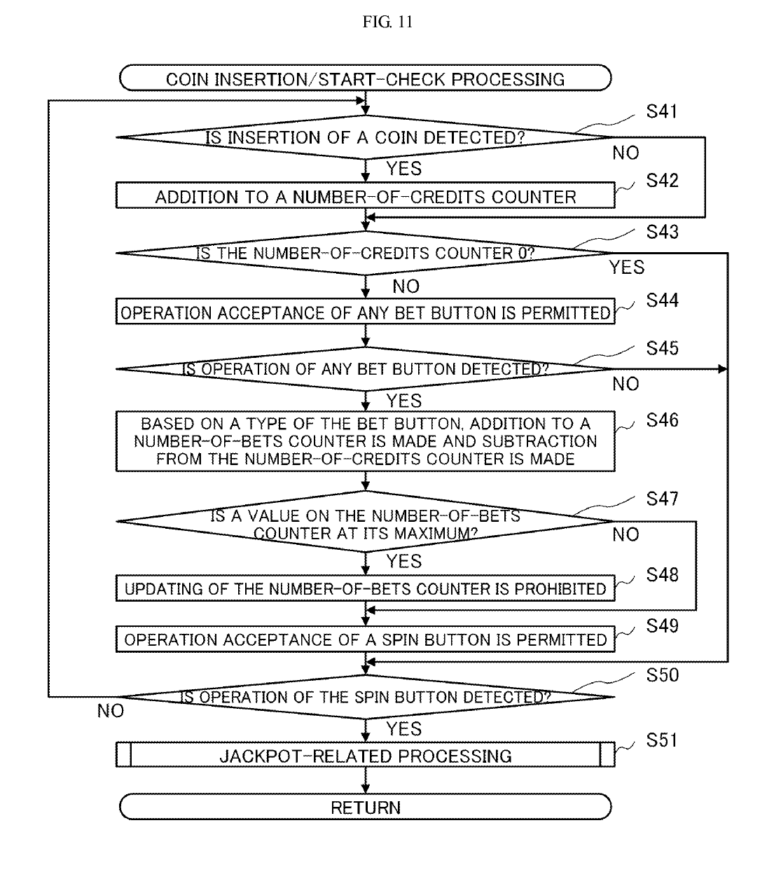

The main CPU 71 conducts coin-insertion/start-check processing which is described later with reference to FIG. 11 (step S13). In the processing, input from the BET switch and the spin switch is checked.

The main CPU 71 then conducts symbol lottery processing which is described later with reference to FIG. 13 (step S14). In the processing, to-be-stopped symbols are determined based on the random values for symbol determination.

Next, the main CPU 71 conducts predictive effects lottery processing (step S15). In this processing, effects which can be executed, for example, when a free game trigger is established are determined based on a random number value.

Next, the main CPU 71 conducts effect contents determination processing (step S16). The main CPU 71 extracts a random number value for effects and determines any of the effect contents from the predetermined plurality of effect contents by lottery. The main CPU 71, for example, selects one from among a plurality of files for executing previously prepared effect contents by lottery and executes the effects in accordance with the selected file. In addition, the main CPU 71 controls the execution of the later-described effects for the basic game.

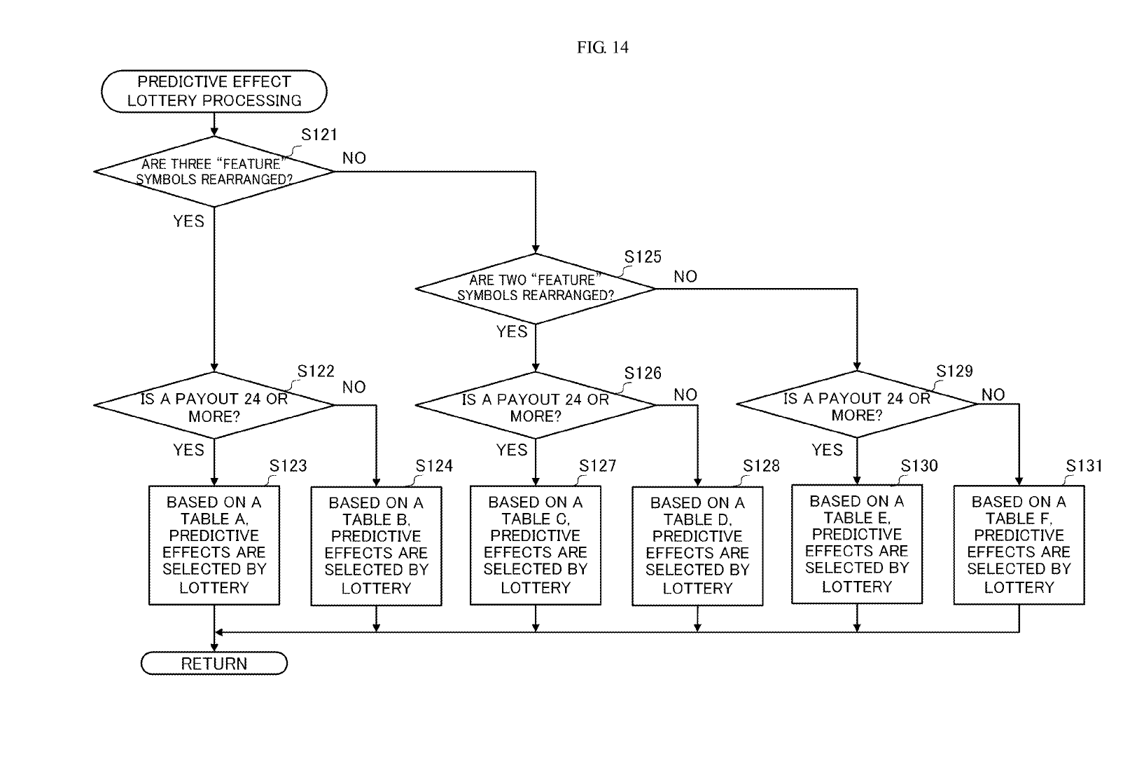

The main CPU 71 then conducts symbol display control processing which is described later with reference to FIG. 14 (step S17). In the processing, scrolling of the symbol array of each video reel 3 is started, and the to-be-stopped symbol determined in the symbol lottery processing of step S14 is stopped at a predetermined position (for example, the upper region in the symbol display region 4). That is, four symbols including the to-be-stopped symbol are displayed in the symbol display region 4. For example, when the to-be-stopped symbol is the symbol associated with the code number=10 and it is to be displayed to the upper region, the symbols associated with the respective code numbers=11, 12 and 13 are to be displayed in the respective upper central region, lower central region and lower region in the symbol display region 4.

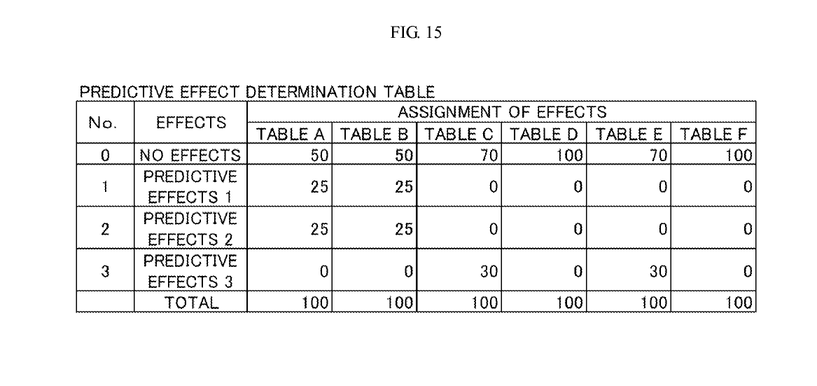

Next, the main CPU 71 conducts to-be-paid-out number determination processing which is described later with reference to FIG. 15 (step S18). In the processing, the number of gaming media to be paid out is determined based on the combination of symbols displayed along the winning line and is stored into a to-be-paid-out number storage area provided in the RAM 73. In addition, to-be-paid-out number determination processing in free game processing is separately conducted in the free game processing which is described later with reference to FIG. 16.

Next, the main CPU 71 determines whether or not the free game trigger has been established (step S19). When the main CPU 71 determines that the free game trigger has been established (for example, when the “FEATURE” symbols are displayed in the stopped manner on the second, third, and fourth reels), the main CPU 71 conducts the free game processing which is described later with reference to FIG. 16 (step S20).

The main CPU 71 conducts payout processing (step S23). The main CPU 71 adds the value stored in the to-be-paid-out number storage area to a value stored in a number-of-credits storage area provided in the RAM 73. It is to be noted that operations of the hopper 113 may be controlled based on input from the CASHOUT switch 33S, and coins of the number corresponding to the value stored in the to-be-paid-out number storage area may be discharged from the coin payout exit 15A. In addition, operations of the ticket printer 171 may be controlled and a ticket with a barcode may be issued on which a value stored in the to-be-paid-out number storage area is recorded. After the processing has been conducted, the processing is shifted to step S12.

<Coin-Insertion/Start-Check Processing>

Next, with reference to FIG. 11, coin-insertion/start-check processing will be described. FIG. 11 is a view illustrating a flowchart of the coin-insertion/start-check processing for the gaming machine according to the embodiment of the present invention.

First, the main CPU 71 determines whether or not insertion of a coin has been detected by the coin counter 92C (step S41). When determining that the insertion of a coin has been detected by the coin counter 92C, the main CPU 71 makes an addition to the value stored in the number-of-credits storage area (the number-of-credits counter) (step S42). It is to be noted that, in addition to the insertion of a coin, the main CPU 71 may determine whether or not insertion of a bill has been detected by the bill validator 115, and when determining that the insertion of a bill has been detected, the main CPU 71 may add a value according to the bill to the value stored in the number-of-credits storage area.

After step S42 or when determining in step S41 that the insertion of any coin has not been detected, the main CPU 71 determines whether or not the value stored in the number-of-credits storage area is zero (step S43). When the main CPU 71 determines that the value stored in the number-of-credits storage area is not zero, the main CPU 71 permits operation acceptance of the BET buttons (step S44).

Next, the main CPU 71 determines whether or not operation of any of the BET buttons has been detected (step S45). When the main CPU 71 determines that the BET switch has detected press of the BET button by a player, the main CPU 71 makes an addition to a value stored in a number-of-BETs storage area provided in the RAM 73 and makes a subtraction from the value stored in the number-of-credits storage area, based on the type of the BET button (step S46).

The main CPU 71 then determines whether or not the value stored in the number-of-BETs storage area is at its maximum (step S47). When the main CPU 71 determines that the value stored in the number-of-BETs storage area is at its maximum, the main CPU 71 prohibits updating of the value stored in the number-of-BETs storage area (step S48). After step S48 or when determining in step S47 that the value stored in the number-of-BETs storage area is not at its maximum, the main CPU 71 permits operation acceptance of the spin button (step S49).

After step S49 or when determining in step S45 that the operation of any of the BET buttons has not been detected, or when determining in step S43 that the value stored in the number-of-credits storage area is zero, the main CPU 71 determines whether or not operation of the spin button has been detected (step S50). When the main CPU 71 determines that the operation of the spin button has not been detected, the processing is shifted to step S41.

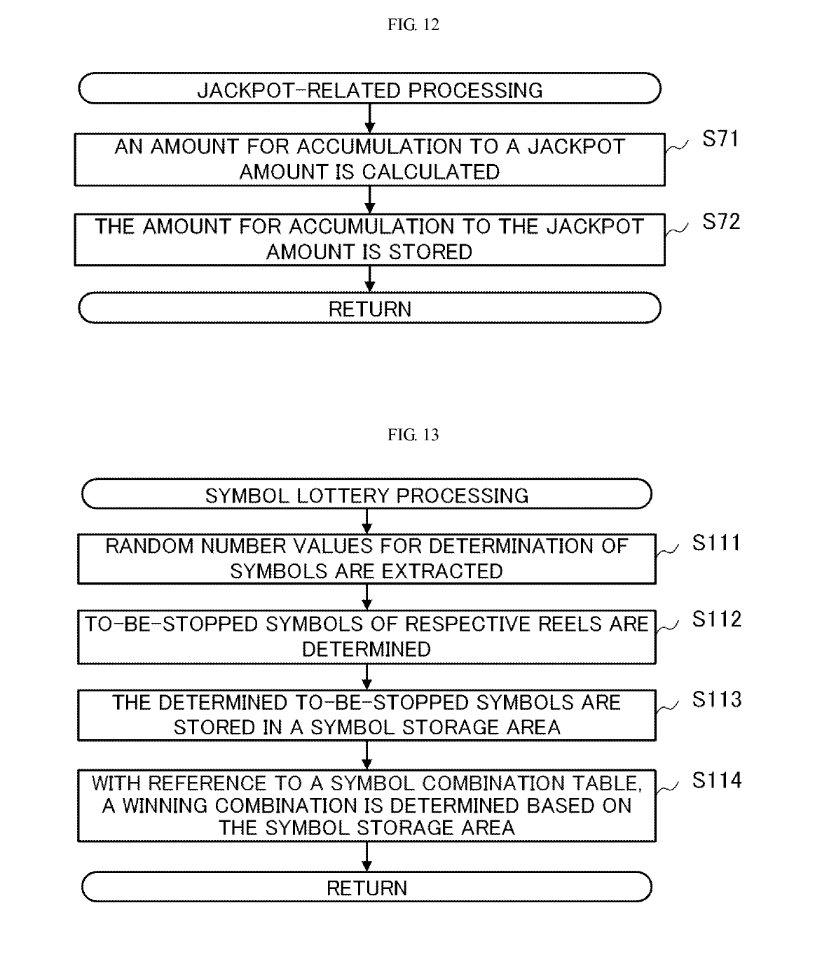

When the main CPU 71 determines that the operation of the spin button has been detected, the main CPU 71 conducts jackpot-related processing which is described later with reference to FIG. 12 (step S51). In the processing, the amount for accumulation (accumulated amount) to the amount of a jackpot is calculated and the accumulated amount and the jackpot amount are added and the resultant is stored in a jackpot amount storage area. After this processing has been conducted, the coin-insertion/start-check processing is finished.

<Jackpot-Related Processing>

Now, with reference to FIG. 12, the jackpot-related processing will be described. FIG. 12 is a view illustrating a flowchart of the jackpot-related processing for the gaming machine according to the embodiment of the present invention.

First, the main CPU 71 calculates the amount for accumulation (step S71). The main CPU 71 obtains the product of the value stored in the number-of-BETs storage area and a preset accumulation ratio, so that the amount for accumulation to the amount of a jackpot is calculated.

Next, the main CPU makes an addition of the calculated amount for accumulation to the jackpot amount and the jackpot amount and stores the resultant in the jackpot amount storage area (step S72). After this processing has been conducted, the jackpot-related processing is finished. It is to be noted that if the jackpot is of a network type, the amount for accumulation to the jackpot amount is transmitted to the external control device 200 and upon receiving the amount for accumulation to the jackpot amount, the external control device 200 updates the jackpot amount.

<Symbol Lottery Processing>

Next, with reference to FIG. 13, the symbol lottery processing will be described. FIG. 13 is a view illustrating a flowchart of the symbol lottery processing for the gaming machine according to the embodiment of the present invention.

First, the main CPU 71 extracts random values for symbol determination (step S111). Next, the main CPU 71 determines to-be-stopped symbols for the respective video reels 3 by lottery (step S112). The main CPU 71 holds a lottery for each video reel 3 and determines any one among the plurality of symbols as a to-be-stopped symbol. At this time, on the first reel, each of the 88 symbols is determined at an equal probability (i.e. 1/88).

The main CPU 71 then stores the determined to-be-stopped symbols for the respective video reels 3 into a symbol storage area provided in the RAM 73 (step S113). Next, the main CPU 71 references the winning line definition table and the payout table and determines a payout (winning combination) based on the symbol storage area (step S114). The main CPU 71 determines the payout (winning combination) based on the number of symbols displayed on the winning line by the respective video reels 3. After this processing has been conducted, the symbol lottery processing is finished.

<Predictive Effect Lottery Processing>

Next, with reference to FIG. 14, predictive effect lottery processing will be described. FIG. 14 is a view illustrating a flowchart of the predictive effect lottery processing for the gaming machine according to the embodiment of the present invention.

First, based on the to-be-stopped symbols stored in the symbol storage area in the processing at step S113 in FIG. 13, the main CPU 71 determines whether or not three “FEATURE” symbols are rearranged in the symbol display regions 4 of the lower image display panel 141 (step S121). When this determination is YES, based on the payout determined at step S114 in FIG. 13, the main CPU 71 determines whether or not a payout is 24 or more (step S122). When this determination is YES, based on a table A (which is described later with reference to FIG. 15), the main CPU 71 selects predictive effects by lottery (step S123). On the other hand, when this determination is NO, based on a table B (which is described later with reference to FIG. 15), the main CPU 71 selects predictive effects by lottery (step S124). After the processing at step S123 or S124 has been conducted, the predictive effect lottery processing is finished.

When NO is determined at step S121, based on the to-be-stopped symbols stored in the symbol storage area in the processing at step S113 in FIG. 13, the main CPU 71 determines whether or not two “FEATURE” symbols are rearranged in the symbol display regions 4 of the lower image display panel 141 (step S125). When this determination is YES, based on the payout determined at step S114 in FIG. 13, the main CPU 71 determines whether or not a payout is 24 or more (step S126). When this determination is YES, based on a table C (which is described later with reference to FIG. 15), the main CPU 71 selects predictive effects by lottery (step S127). On the other hand, when this determination is NO, based on a table D (which is described later with reference to FIG. 15), the main CPU 71 selects predictive effects by lottery (step S128). After the processing at step S127 or S128 has been conducted, the predictive effect lottery processing is finished.

When NO is determined at step S125, based on the payout determined at step S114 in FIG. 13, the main CPU 71 determines whether or not a payout is 24 or more (step S129). When this determination is YES, based on a table E (which is described later with reference to FIG. 15), the main CPU 71 selects predictive effects by lottery (step S130). On the other hand, when this determination is NO, based on a table F (which is described later with reference to FIG. 15), the main CPU 71 selects predictive effects by lottery (step S131). After the processing at step S130 or S131 has been conducted, the predictive effect lottery processing is finished.

<Predictive Effect Determination Table>

FIG. 15 is a view illustrating a predictive effect determination table. This predictive effect determination table is comprised of six tables, which are the tables A, B, C, D, E, and E The tables A, B, C, D, E, and F are referenced respectively at steps S123, S124, S127, S128, S130, and S131 in FIG. 14. For example, in the table A, no effects in No. 0 are selected with a probability of 50/100, predictive effects 1 in No. 1 are selected with a probability of 25/100, and predictive effects 2 in No. 2 are selected with a probability of 25/100.

In the predictive effect lottery processing shown in FIG. 14 and with reference to the predictive effect determination table show in FIG. 15, when three “FEATURE” symbols are rearranged in the symbol display regions 4 of the lower image display panel 141, the predictive effects 1 or the predictive effects 2 are selected. In addition, when two “FEATURE” symbols are rearranged in the symbol display regions 4 of the lower image display panel 141 or one or less “FEATURE” symbol is rearranged in the symbol display regions 4 of the lower image display panel 141 and only in a case where the payout is 24 or more, predictive effects 3 are selected.

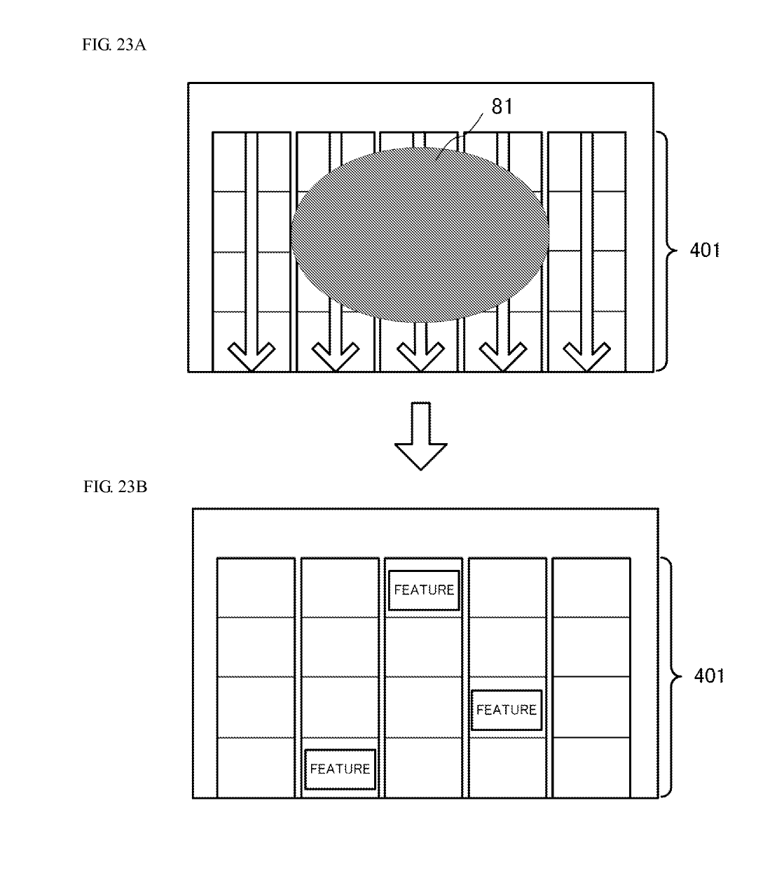

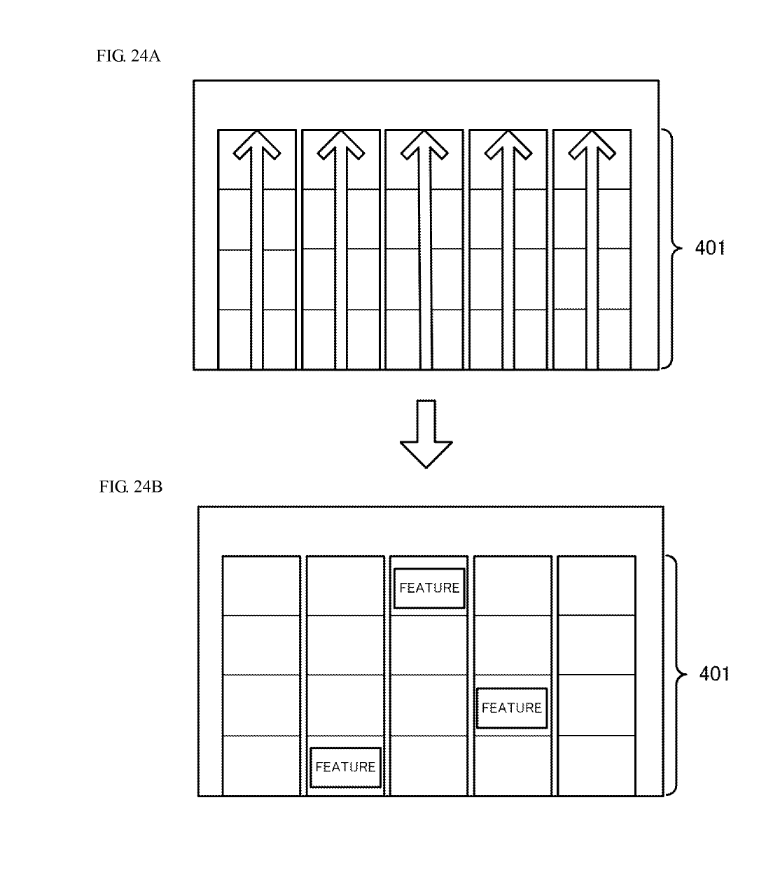

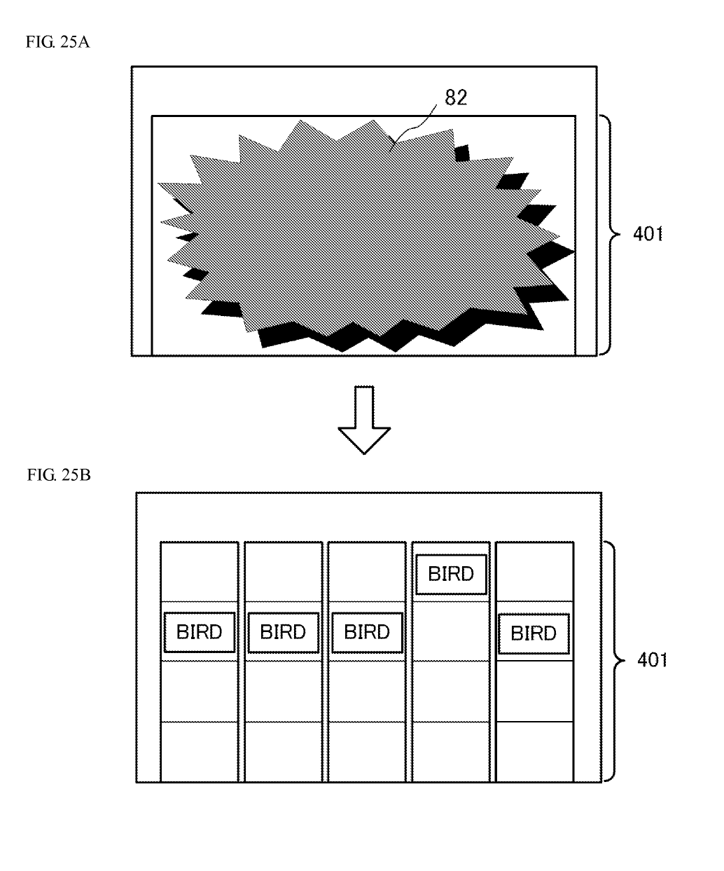

Here, with reference to FIGS. 23A to 25B, the kinds of predictive effects of the predictive effects 1 to the predictive effects 3 will be described. FIGS. 23A and 23 B show effect contents of the predictive effects 1 which are selected when the three “FEATURE” symbols are rearranged in the symbol display regions 4 of the lower image display panel, that is, when the free game trigger is established. FIGS. 24A and 24B show effect contents of the predictive effects 2 which are selected when the free game trigger is established, as with the predictive effects 1. FIGS. 25A and 25B show effect contents of the predictive effects 3 which are selected when the two “FEATURE” symbols are rearranged in the symbol display regions 4 of the lower image display panel 141 or one or less “FEATURE” symbol is rearranged in the symbol display regions 4 of the lower image display panel 141 and only in the case where the payout is 24 or more.

In FIG. 23A, it is illustrated that after the spin button 31 has been pressed down, an image 81 of a big ball is displayed on a screen 401 of the lower image display panel 141. While this is being displayed, a period of time during which the scrolling of the respective video reels 3 is conducted is made longer than a normal period of time. After the image 81 of the big ball has disappeared, as show in FIG. 23B, three “FEATURE” symbols are rearranged.

In FIG. 24A, it is illustrated that after the spin button 31 has been pressed down, the respective video reels 3 are rotated in a reverse direction (upward direction). After a predetermined period of time has passed, as shown in FIG. 24B, three “FEATURE” symbols are rearranged.

In FIG. 25A, it is illustrated that after the spin button 31 has been pressed down, images 82 of the dragon and the tiger are displayed on the whole of the screen 401 of the lower image display panel 141. After a predetermined period of time has passed, as shown in FIG. 25B, for example, five “BIRD” symbols which result in the payout of 24 or more are rearranged along a winning line of No. 14.

<Symbol Display Control Processing>

Next, with reference to FIG. 16, the symbol display control processing will be described. FIG. 16 is a view illustrating a flowchart of the symbol display control processing for the gaming machine according to the embodiment of the present invention.

First, the main CPU 71 starts scrolling of the symbol arrays of the respective video reels 3 that are displayed in the symbol display region 4 of the lower image display panel 141 (step S141). Next, the main CPU 71 executes predictive effects determined in the predictive effect lottery processing which is described with reference to FIG. 14 (step S142). The specific content is as described with reference to FIGS. 23A to 25B. Next, the main CPU 71 stops the scrolling of the symbol arrays of the respective video reels 3 based on the aforementioned symbol storage area (step S143). After this processing has been conducted, the symbol display control processing is finished.

<To-be-Paid-Out Number Determination Processing>

Next, with reference to FIG. 17, the to-be-paid-out number determination processing will be described. FIG. 17 is a view illustrating a flowchart of the to-be-paid-out number determination processing for the gaming machine according to the embodiment of the present invention.

First, the main CPU 71 determines whether or not the winning combination is associated with the free games (step S151). When the main CPU 71 determines that the winning combination is not associated with the free games, the main CPU 71 determines a number of gaming media to be paid out, which corresponds to the winning combination (step S152). For example, when a predetermined number of predetermined symbols are displayed on a winning line (as defined in the payout table), a corresponding payout defined in the payout table is determined and a number of gaming media to be paid out is determined from this payout and a number of BETs. Upon losing, as a number of gaming media to be paid out, “0” is determined. In addition, when four special symbols (the special symbols are the “DRAGON” symbols and the “TIGER” symbols) whose kind is the same are consecutively rearranged on all of the video reels 3, that is, when the special symbols whose kind is the same are rearranged in all of the symbol display regions 4, a payout of a jackpot is determined as a number of gaming media to be paid out. Next, the main CPU 71 stores the determined number of gaming media to be paid out into the to-be-paid-out number storage area (step S153). After this processing has been conducted, the to-be-paid-out number determination processing is finished.

<Free Game Processing>

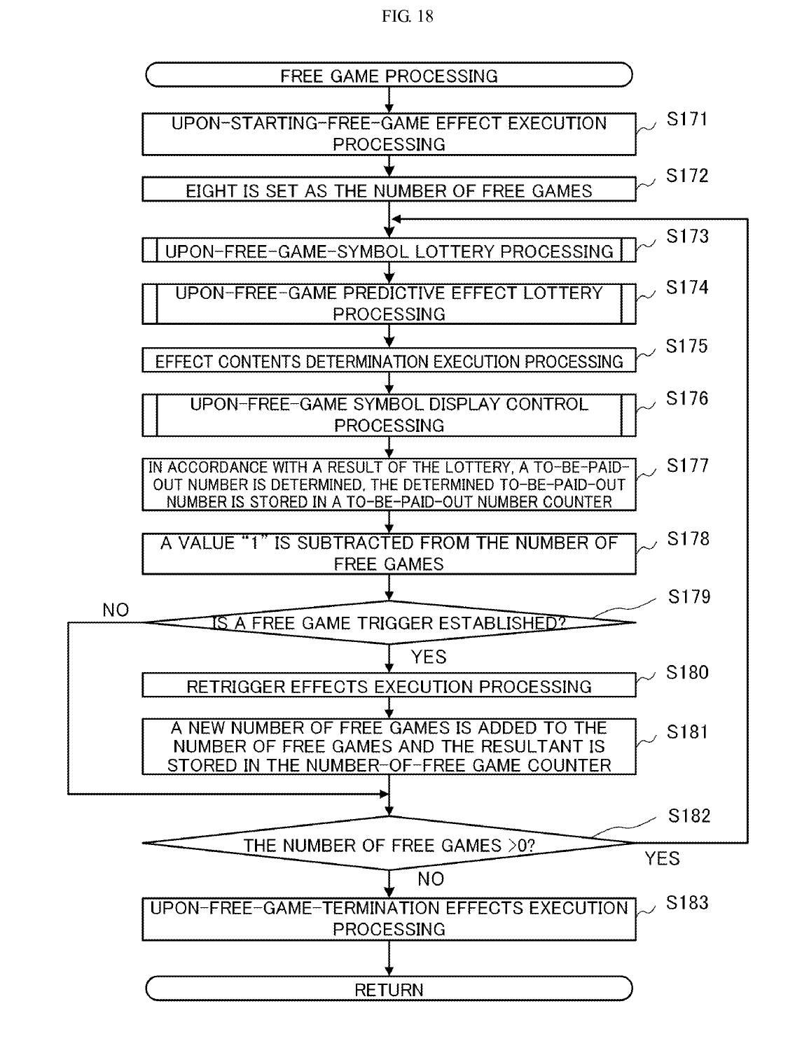

Next, with reference to FIG. 18 to FIG. 22, free game processing will be described. FIG. 18 is a view illustrating a flowchart of the free game processing for the gaming machine according to the embodiment of the present invention.

The main CPU 71 conducts upon-starting-free-game effect execution processing (step S171). In this processing, for example, when the free game trigger is established in the basic game and the free games are started, the speaker 112 is caused to output sound effects (SE) related to the starting of the free games and a notice indicating that the free games are started is displayed on the lower image display panel 141, and thereafter, the display contents on the upper image display panel 131 and the lower image display panel 141 are switched and free game introduction effects are displayed on the lower image display panel 141.

Next, the main CPU 71 sets a number of free games to eight and stores the set number of free games in a number-of-free-game storage area provided in the RAM 73 (step S172). This is to control the eight free games to be executed, and one is subtracted from the number of free games at step S177 each time each of the free games is executed.

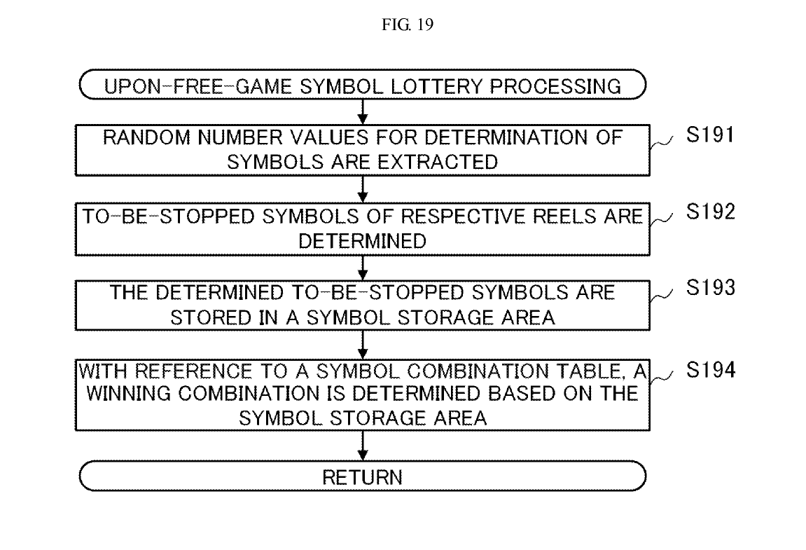

Next, the main CPU 71 conducts upon-free-game-symbol-lottery processing which is described later with reference to FIG. 19 (step S173). In this processing, based on random number values for determination of symbols related to the free games, to-be-stopped symbols are determined.

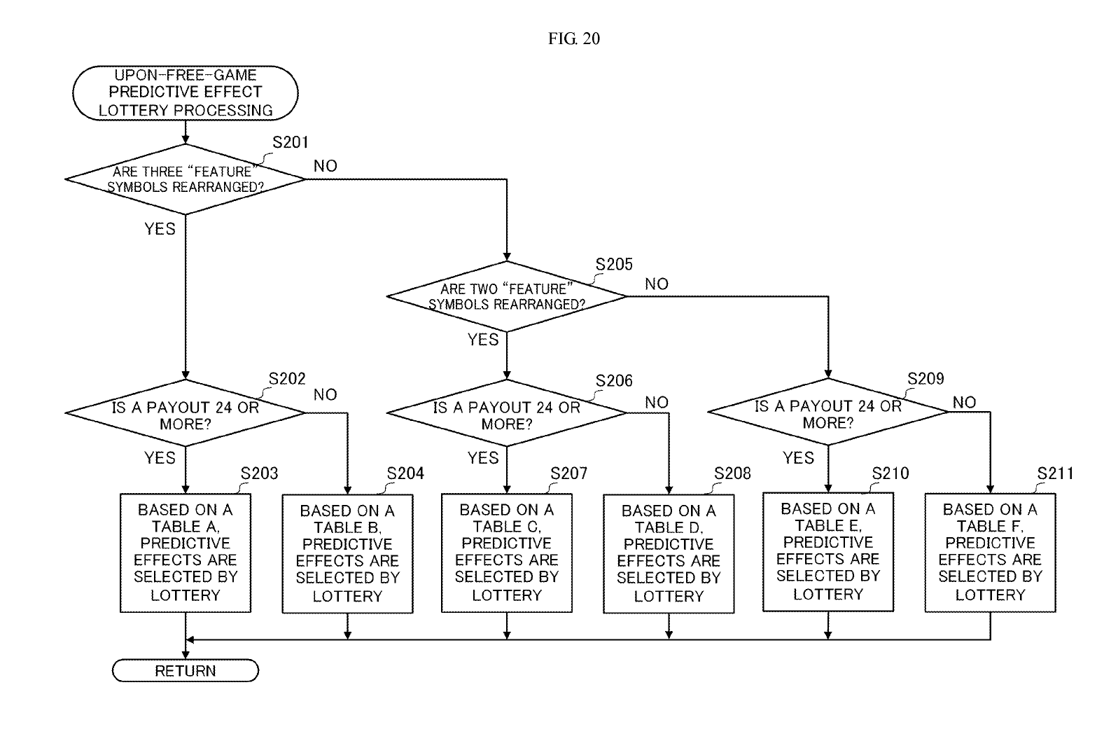

Next, the main CPU 71 conducts upon-free-game predictive effect lottery processing which is described later with reference to FIG. 20 (step S174). In this processing, effects which can be executed when the payout is 24 are determined based on random number values.

Next, the main CPU 71 conducts effect contents determination execution processing (step S175). The main CPU 71 determines an effect contents definition file in accordance with the situation of the progress of free games and executes effects in accordance with the determined effect contents definition file. In addition, the main CPU 71 controls the execution of the later-described effects in the free games.

Next, the main CPU 71 conducts upon-free-game symbol display control processing which is described later with reference to FIG. 22 (step S176). In this processing, when four consecutive special symbols are rearranged on any of the video reels 3, the main CPU 71 determines whether or not one or more said special symbol(s) is/are rearranged on the other video reels 3. When one or more special symbol(s) is/are rearranged, the video reel(s) 3 on which said one or more special symbols are rearranged are nudged and further rotating display is conducted such that the four consecutive special symbols are rearranged. Here, to nudge is to display said video reels 3 so as to move in a vertical direction or a direction opposite thereto such that in the display regions corresponding to the video reels 3 on which at least one special symbols are rearranged, special symbols are rearranged in all regions in a vertical direction of the display regions.

Next, the main CPU 71 conducts to-be-paid-out number determination processing related to the free games (step S177). In this processing, based on the payout table shown in FIG. 8A, the main CPU 71 determines a payout related to a number of symbols displayed on each winning line defined in the winning line definition table shown in FIG. 7B, determines a number of gaming media to be paid out from said payout and a number of BETs, and stores the determined number of gaming media to be paid out in the to-be-paid-out number storage area provided in the RAM 73. When the four consecutive special symbols whose kind is the same (the special symbols are the “DRAGON” symbols and the “TIGER” symbols) are rearranged on all video reels 3, that is, when the special symbols whose kind is the same are rearranged on all of the symbol display regions 4, a payout of a jackpot is determined as a number of gaming media to be paid out.

Next, the main CPU 71 subtracts one from the number of free games and stores the resultant in the number-of-free-game storage area provided in the RAM 73 (step S178). Next, the main CPU 71 determines whether or not the free game trigger is established during the execution of the free games (step S179). When the main CPU 71 determines that the free game trigger has been established (for example, when the “FEATURE” symbols are displayed in the stopped manner on the second, third, and fourth reels), the main CPU 71 conducts retrigger effects execution processing (step S180). For example, when the free game trigger has been established, the speaker 112 is caused to output sound effects (SE) related to the retrigger and a notice indicating that the retrigger has been established is displayed on the lower image display panel 141, whereby the retrigger effects execution processing is conducted.

Next, the main CPU 71 adds a number of free games (for example, eight free games) newly added by the establishment of the free game trigger to the number of free games stored in the number-of-free-game storage area provided in the RAM 73 (step S181).

Next, the main CPU 71 determines whether or not the number of free games stored in the number-of-free-game storage area provided in the RAM 73 is larger than zero (step S182) and when it is determined that the number of free games is larger than zero, the main CPU 71 shifts to step S173 and starts the new free games. On the other hand, when the number of free games is less than or equal to zero, the free games are terminated and the main CPU 71 conducts upon-free-game-termination effects execution processing (step S183). For example, when it is determined that the free games are terminated, the speaker 112 is caused to output sound effects (SE) related to the termination of the free games and a notice indicating that the free games have been terminated is displayed on the lower image display panel 141, whereby the upon-free-game-termination effects execution processing is conducted. After this processing has been conducted, the free game processing is finished.

<Upon-Free-Game-Symbol-Lottery Processing>

Next, with reference to FIG. 19, upon-free-game-symbol-lottery processing will be described. FIG. 19 is a view illustrating a flowchart of the upon-free-game-symbol-lottery processing for the gaming machine according to the embodiment of the present invention.

First, the main CPU 71 extracts random number values for determination of upon-free-game symbols (step S191). Next, the main CPU 71 determines to-be-stopped symbols of the respective video reels 3 by lottery (step S192). The main CPU 71 conducts the lottery for the respective video reels 3 and determines any of the plurality of symbols as the to-be-stopped symbols. At this time, for example, on the first reel, each of the 92 symbols (code numbers=0 to 91) is determined with an equal probability (that is, 1/92).

Next, the main CPU 71 stores the determined to-be-stopped symbols of the respective video reels 3 in an upon-free-game symbol storage area provided in the RAM 73 (step S193). Next, the main CPU 71 references the winning line definition table shown in FIG. 7B and the payout table shown in FIG. 8A and determines a payout (winning combination) based on the upon-free-game symbol storage area (step S194). The main CPU 71 determines the payout (winning combination) based on a number of symbols displayed on a winning line by the respective video reels 3. After this processing has been conducted, the upon-free-game-symbol-lottery processing is finished.

<Upon-Free-Game Predictive Effect Lottery Processing>

Next, with reference to FIG. 20, upon-free-game predictive effect lottery processing will be described. FIG. 20 is a view illustrating a flowchart of the upon-free-game predictive effect lottery processing for the gaming machine according to the embodiment of the present invention.

First, based on the to-be-stopped symbols stored in the symbol storage area in the processing at step S193 in FIG. 19, the main CPU 71 determines whether or not three “FEATURE” symbols are rearranged in the symbol display regions 4 of the lower image display panel 141 (step S201). When this determination is YES, based on the payout determined at step S194 in FIG. 19, the main CPU 71 determines whether or not a payout is 24 or more (step S202). When this determination is YES, based on a table A (which is described later with reference to FIG. 21), the main CPU 71 selects predictive effects by lottery (step S203). On the other hand, when this determination is NO, based on a table B (which is described later with reference to FIG. 21), the main CPU 71 selects predictive effects by lottery (step S204). After the processing at step S203 or S204 has been conducted, the upon-free-game predictive effect lottery processing is finished.

When NO is determined at step S201, based on the to-be-stopped symbols stored in the symbol storage area in the processing at step S193 in FIG. 19, the main CPU 71 determines whether or not two “FEATURE” symbols are rearranged in the symbol display regions 4 of the lower image display panel 141 (step S205). When this determination is YES, based on the payout determined at step S194 in FIG. 19, the main CPU 71 determines whether or not a payout is 24 or more (step S206). When this determination is YES, based on a table C (which is described later with reference to FIG. 21), the main CPU 71 selects predictive effects by lottery (step S207). On the other hand, when this determination is NO, based on a table D (which is described later with reference to FIG. 21), the main CPU 71 selects predictive effects by lottery (step S208). After the processing at step S207 or S208, the upon-free-game predictive effect lottery processing is finished.

When NO is determined at step S205, based on the payout determined at step S194 in FIG. 19, the main CPU 71 determines whether or not a payout is 24 or more (step S209). When this determination is YES, based on a table E (which is described later with reference to FIG. 21), the main CPU 71 selects predictive effects by lottery (step S210). On the other hand, when this determination is NO, based on a table F (which is described later with reference to FIG. 21), the main CPU 71 selects predictive effects by lottery (step S211). After the processing at step S210 or S211 has been conducted, the upon-free-game predictive effect lottery processing is finished.

<Upon-Free-Game Predictive Effect Determination Table>

FIG. 21 is a view illustrating an upon-free-game predictive effect determination table. This upon-free-game predictive effect determination table is comprised of six tables, which are the tables A, B, C, D, E, and E The tables A, B, C, D, E, and F are referenced respectively at steps S203, S204, S207, S208, S210, and S211 in FIG. 20. For example, in the table C, no effects in No. 0 is selected with a probability of 70/100 and predictive effects 1 in No. 3 is selected with a probability of 30/100.

In the upon-free-game predictive effect lottery processing shown in FIG. 20 and with reference to the upon-free-game predictive effect determination table shown in FIG. 21, when two “FEATURE” symbols are rearranged in the symbol display regions 4 of the lower image display panel 141 or one or less “FEATURE” symbol is rearranged in the symbol display regions 4 of the lower image display panel 141 and only in a case where the payout is 24 or more, predictive effects 3 are selected. In the free games, predictive effects 1 and predictive effects 2 are not selected. Effect contents of the predictive effects 3 are as described above with reference to FIGS. 25A and 25B.

<Upon-Free-Game Symbol Display Control Processing>

Next, with reference to FIG. 22, upon-free-game symbol display control processing will be described. FIG. 22 is a view illustrating a flowchart of the upon-free-game symbol display control processing for the gaming machine according to the embodiment of the present invention.

First, the main CPU 71 starts scrolling of the symbol arrays of the respective video reels 3 displayed in the symbol display regions 4 of the lower image display panel 141 (step S221). Next, the main CPU 71 executes the predictive effects determined in the upon-free-game predictive effect lottery processing described above with reference to FIG. 20 (step S222). The specific contents are as described above with reference to FIGS. 23A to 25B. Next, the main CPU 71 stops the scrolling of the symbol arrays of the respective video reels 3 (step S223).

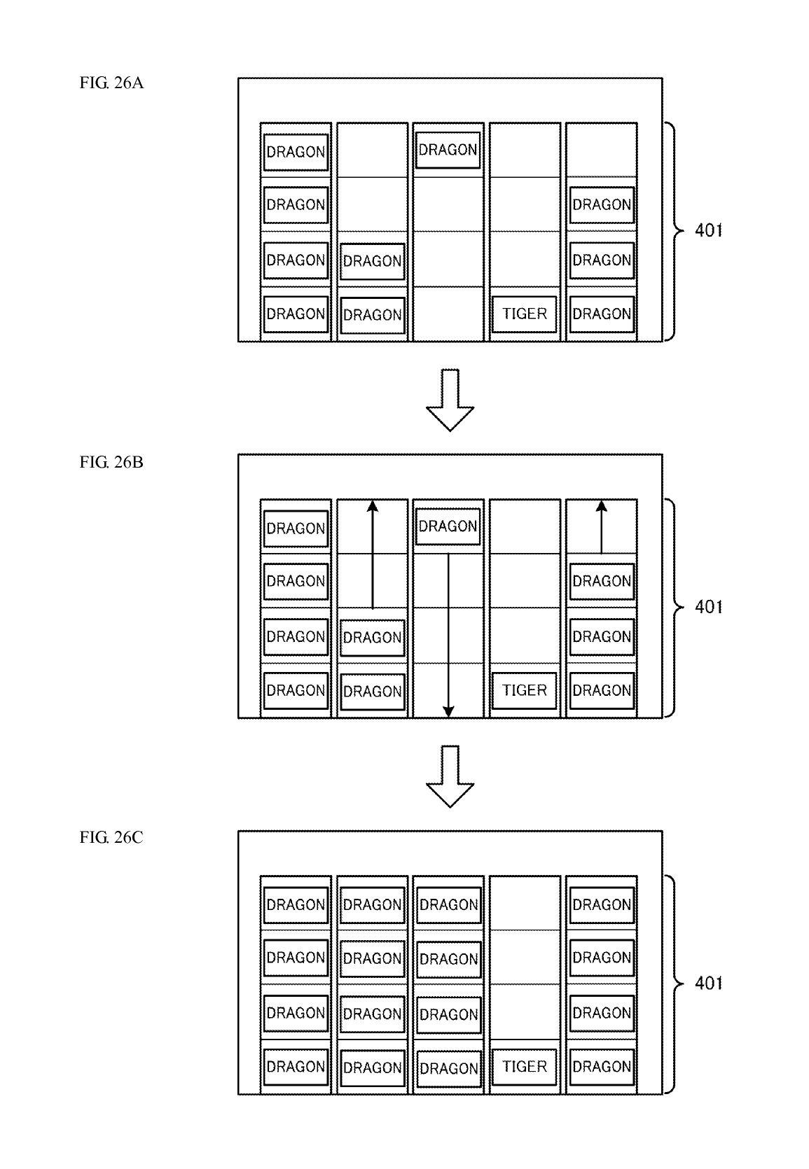

Next, the main CPU 71 determines whether or not four consecutive special symbols (the special symbols are the “DRAGON” symbols or the “TIGER” symbols) whose kind is the same are rearranged in the display regions which correspond to any of the video reels 3, among the symbol display regions 4 (step S224). When this determination is YES, the main CPU 71 determines whether or not one or more special symbols whose kind is the same as that of said special symbols are rearranged in display regions which correspond to video reels 3 being different from the video reels 3 which correspond to the display regions in which the four consecutive special symbols whose kind is the same are rearranged (step S225). When this determination is YES, the main CPU 71 display the video reel(s) 3, which correspond(s) to the display regions in which said one or more special symbol(s) whose kind is the same is/are rearranged, so as to move in an upward direction or a downward direction and further rearranges the video reels 3 so as to become four consecutive special symbols whose kind is the same (step S226). In other words, the nudging of said video reels 3 is conducted. After this processing has been conducted, the upon-free-game symbol display control processing is finished. In addition, when the determination at step S224 or step S225 is NO, the upon-free-game symbol display control processing is finished. The effects in the upon-free-game symbol display control processing will be described later with reference to FIGS. 26A to 26C.

<Effects in Upon-Free-Game Symbol Display Control Processing>

Next, with reference to FIGS. 26A to 26C, effects in upon-free-game symbol display control processing will be described. FIGS. 26A to 26C are views illustrating display contents on the screen 401 of the lower image display panel 141 for the gaming machine according to the embodiment of the present invention.

FIG. 26A illustrates a view in which four consecutive “DRAGON” symbols are rearranged in display regions corresponding to the first video reel 3a among the symbol display regions 4; two consecutive “DRAGON” symbols are rearranged in display regions corresponding to the second video reel 3b; one “DRAGON” symbol is rearranged in display regions corresponding to the third video reel 3c; one “TIGER” symbol is rearranged in display regions corresponding to the fourth video reel 3d; and three consecutive “DRAGON” symbols are rearranged in display regions corresponding to the fifth video reel 3e.

FIG. 26B illustrates that stemming from the rearrangement of the four consecutive “DRAGON” symbols in the display regions which correspond to the first video reel 3a, the second video reel 3b, the third video reel 3c, and the fifth video reel 3e are nudged. In other words, in order for four consecutive “DRAGON” symbols to be rearranged on the second video reel 3b, the second video reel 3b is nudged in the upward direction. In addition, in order for four consecutive “DRAGON” symbols to be rearranged on the third video reel 3c, the third video reel 3c is nudged in the downward direction. In addition, in order for four consecutive “DRAGON” symbols to be rearranged on the fifth video reel 3e, the fifth video reel 3e is nudged in the upward direction. The fourth video reel 3d is not nudged because the rearranged symbol is not the “DRAGON” symbol.

FIG. 26C illustrates a view in which as results of the nudging, the four consecutive “DRAGON” symbols are rearranged in the display regions among the symbol display regions 4, which correspond to the first video reel 3a, the second video reel 3b, the third video reel 3c, and the fifth video reel 3e, respectively.

<Modified Example of Effects in Upon-Free-Game Symbol Display Control Processing>

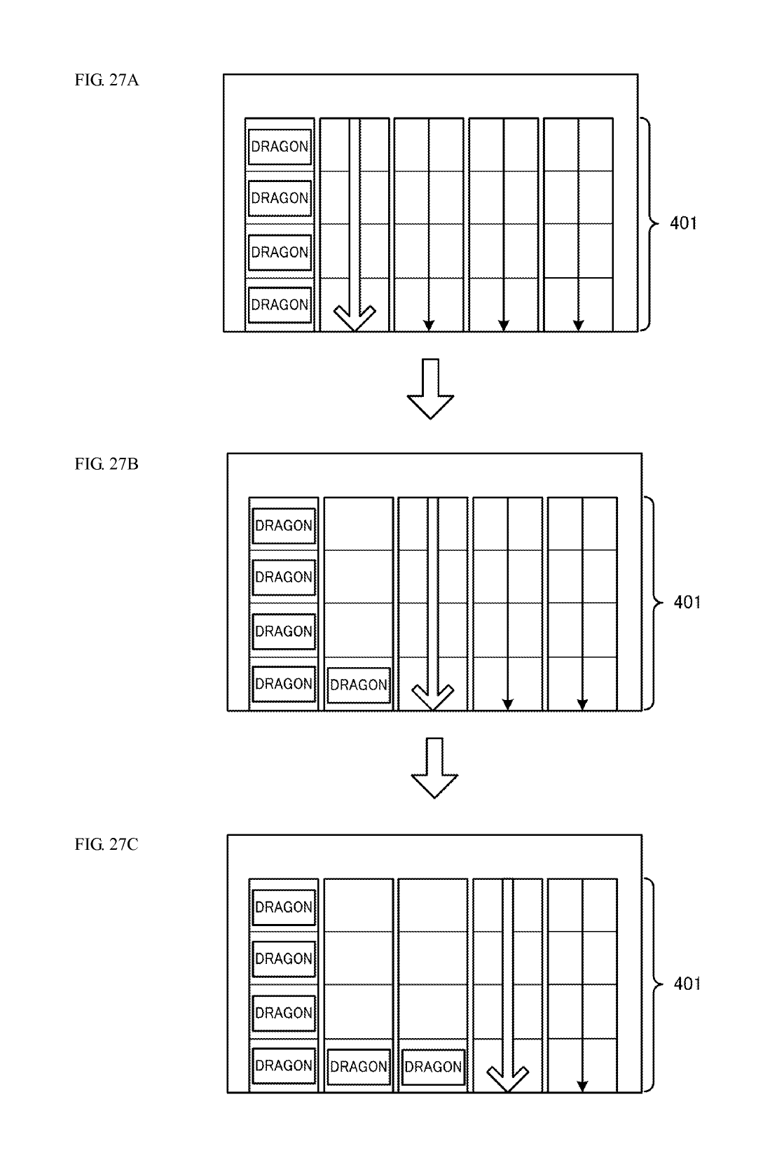

With reference to FIGS. 27A to 30B, a modified example of effects in the upon-free-game symbol display control processing will be described. Each of FIGS. 27A to 30B is a view illustrating display contents on the screen 401 of the lower image display panel 141 for the gaming machine according to the embodiment of the present invention.

FIG. 27A illustrates a view in which four consecutive “DRAGON” symbols are rearranged in the display regions among the symbol display regions 4, which correspond to the first video reel 3a and the other video reels 3 are displayed in a rotating manner. In particular, the second video reel 3b to be stopped next is being displayed in the rotating manner for a longer period of time than a normal period of time during which the video reel is being rotated. Thus, a sense of expectation of one or more “DRAGON” symbol(s) being rearranged in the display regions which correspond to the second video reel 3b can be enhanced.

FIG. 27B illustrates a view in which the second video reel 3b is displayed in the stopped manner and one “DRAGON” symbol is rearranged thereon, and the third video reel 3c, the fourth video reel 3d, and the fifth video reel 3e are being rotated. In particular, the third video reel 3c to be stopped next is being displayed in the rotating manner for the longer period of time than the normal period of time during which the video reel is being rotated. Thus, a sense of expectation of one or more “DRAGON” symbol(s) being rearranged in the display regions which correspond to the third video reel 3c can be enhanced.

FIG. 27C illustrates a view in which the third video reel 3c is displayed in the stopped manner and one “DRAGON” symbol is rearranged thereon, and the fourth video reel 3d and the fifth video reel 3e are being rotated. In particular, the fourth video reel 3d to be stopped next is being displayed in the rotating manner for the longer period of time than the normal period of time during which the video reel is being rotated. Thus, a sense of expectation of one or more “DRAGON” symbol(s) being rearranged in the display regions which correspond to the fourth video reel 3d can be enhanced.

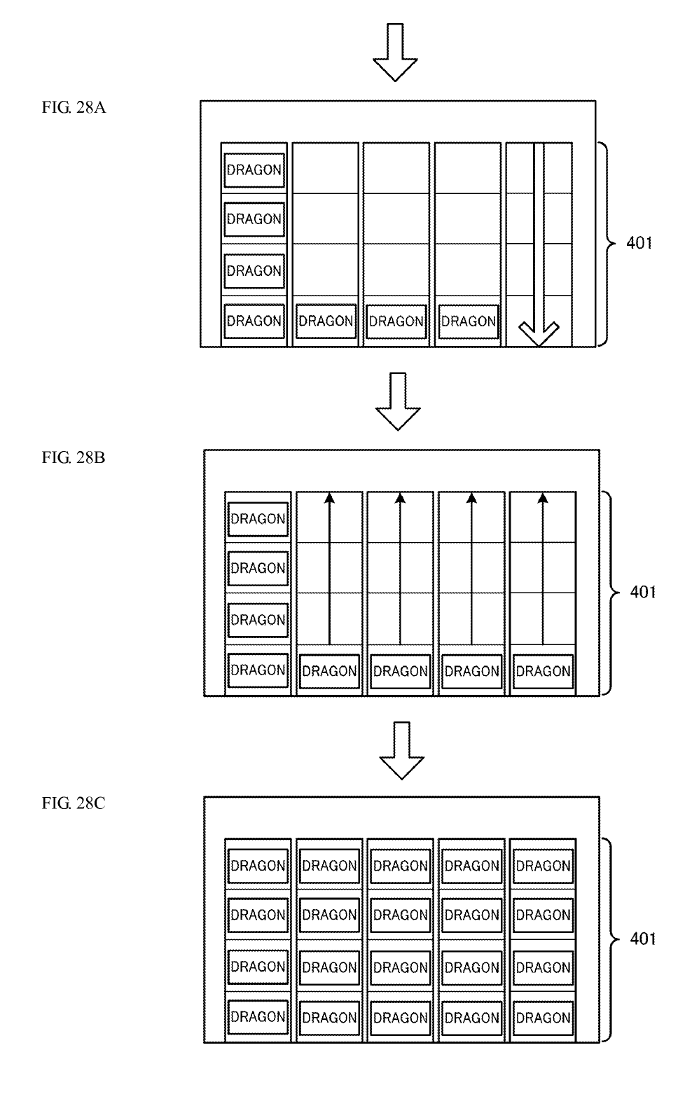

FIG. 28A illustrates a view in which the fourth video reel 3d is displayed in the stopped manner and one “DRAGON” symbol is rearranged thereon, and the fifth video reel 3e is being rotated. In particular, the fifth video reel 3e to be stopped next is being displayed in the rotating manner for the longer period of time than the normal period of time during which the video reel is being rotated. Thus, a sense of expectation of one or more “DRAGON” symbol(s) being rearranged in the display regions which correspond to the fifth video reel 3e can be enhanced.

FIG. 28B illustrates a view in which the second video reel 3b, the third video reel 3c, the fourth video reel 3d, and the fifth video reel 3e are nudged in the upward direction.

FIG. 28C illustrates a view in which as results of the rearrangement of four consecutive “DRAGON” symbols in the display regions which correspond to the second video reel 3b, the third video reel 3c, and the fifth video reel 3e, the four consecutive “DRAGON” symbols are rearranged in the display regions of the symbol display regions 4 which correspond to all of the video reels 3.

As described above, when the four consecutive “DRAGON” symbols are rearranged in the display regions which correspond to the video reel (first video reel 3a) which has initially stopped, the effects by which the period of time during which the video reel (second video reel 3b) to be stopped next is being rotated is made longer than the normal period of time during which the video reel is being rotated are conducted. Such effects are conducted for the video reel 3 to be stopped next when one or more “DRAGON” symbol(s) which is/are the special symbol(s) is/are rearranged. The effects described above are conducted, thereby allowing a sense of expectation of a jackpot being obtained to be enhanced.

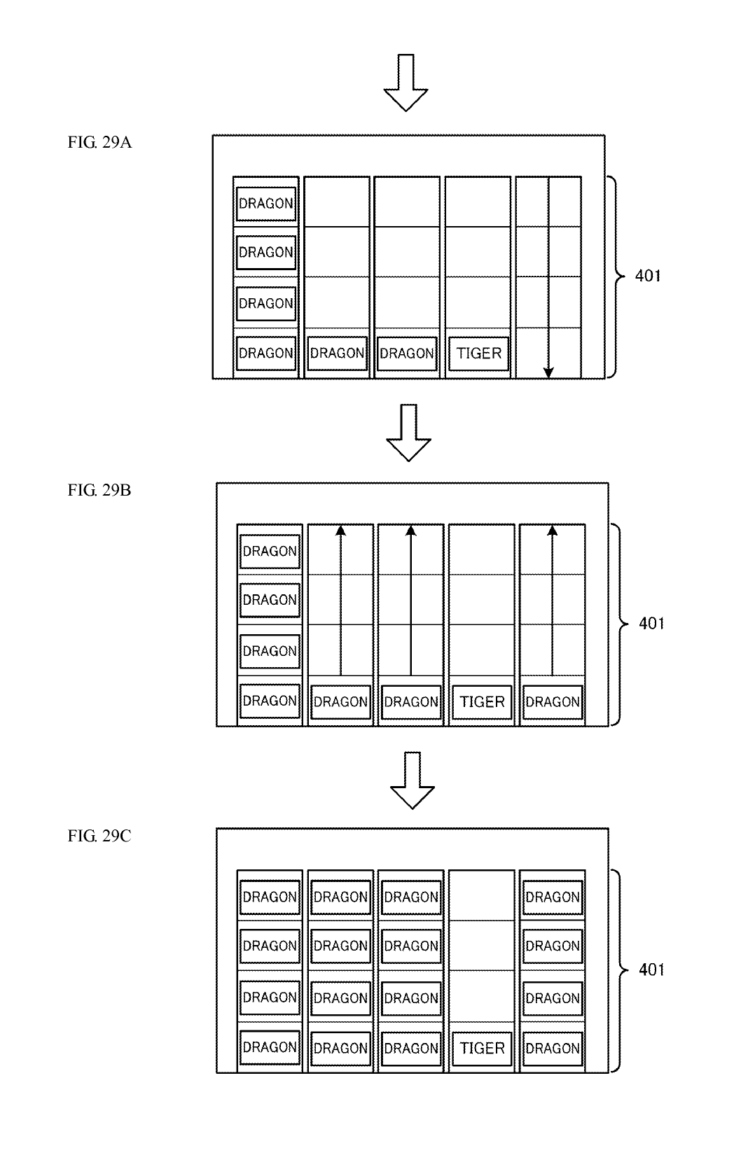

In addition, FIG. 29A illustrates a view in which after the effects described with reference to FIGS. 27A to 27C, the fourth video reel 3d is displayed in the stopped manner, one “TIGER” symbol is rearranged, and the fifth video reel 3e is being rotated. In this case, because no symbol whose kind is the same as that of the four consecutive “DRAGON” symbols is present on the fourth video reel 3d, a period of time during which the fifth video reel 3e is being rotated is the normal period of time during which the video reel is being rotated.

FIG. 29B illustrates a view in which the second video reel 3b, the third video reel 3c, and the fifth video reel 3e are nudged in the upward direction.

FIG. 29C illustrates a view in which as results of the rearrangement of the four consecutive “DRAGON” symbols on the second video reel 3b, the third video reel 3c, and the fifth video reel 3e, the four consecutive “DRAGON” symbols are rearranged in the display regions of the symbol display regions 4 which correspond to all of the video reels 3.

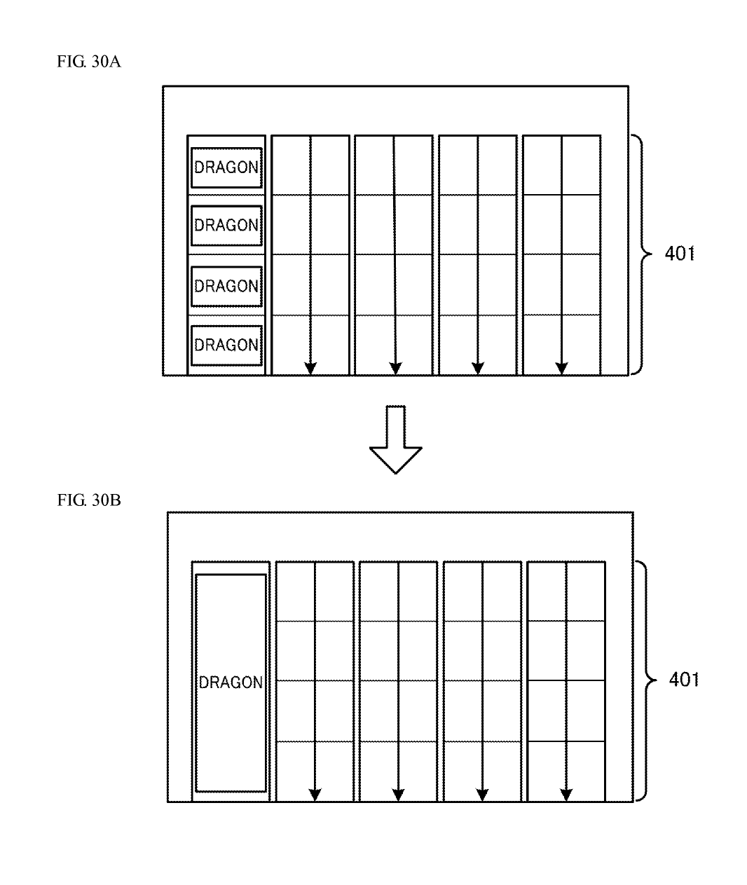

FIG. 30A illustrates a view in which the four consecutive “DRAGON” symbols are rearranged in the display regions among the symbol display regions 4, which correspond to the first video reel 3a. FIG. 30B illustrates a view in which said four consecutive symbols become one picture. This effects shown in FIG. 30B are conducted for a predetermined period of time staring from when displaying of the first video reel 3a in the rotating manner is stopped.

It is to be noted that upon the rearrangement of the four consecutive “DRAGON” symbols in the display regions which correspond to the first video reel 3a, a notice indicating that “when one or more “DRAGON” symbol(s) is/are rearranged in the display regions which correspond to the other video reels 3, on each of which said one or more “DRAGON” symbol(s) is/are rearranged, further displaying thereof in the rotating manner is conducted such that the four consecutive “DRAGON” symbols are rearranged” may be outputted as sound information from the speaker 112.

<Upon-Free-Game Symbol Display Control Processing Related to Modified Example>

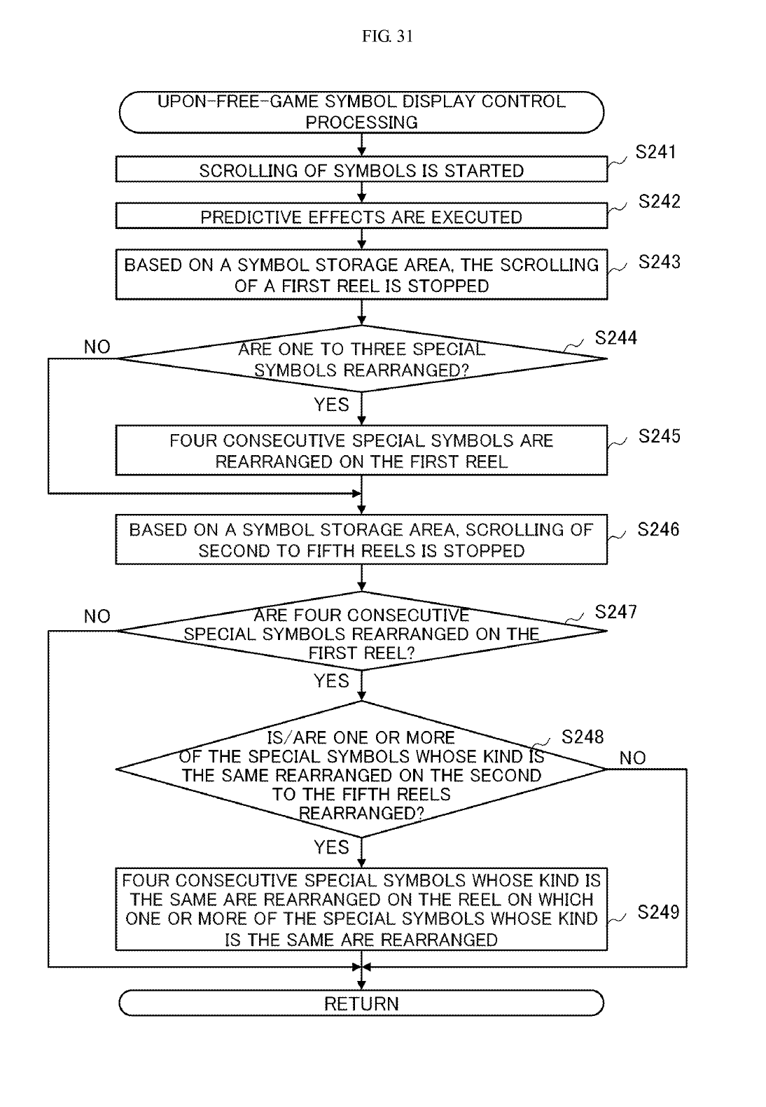

Next, with reference to FIG. 31, upon-free-game symbol display control processing related to the modified example will be described. FIG. 31 is a view illustrating a flowchart of the upon-free-game symbol display control processing for the gaming machine according to the modified example of the embodiment of the present invention. The upon-free-game symbol display control processing related to the present modified example is called up from step S176 in FIG. 18.

First, the main CPU 71 starts scrolling of the symbol arrays of the respective video reels 3 displayed in the symbol display regions 4 of the lower image display panel 141 (step S241). Next, the main CPU 71 executes predictive effects determined in the upon-free-game predictive effect lottery processing which is described above with reference to FIG. 20 (step S242). Specific contents are as described above with reference to FIGS. 23A to 25B. Next, the main CPU 71 stops the scrolling of the symbol arrays of the first video reel 3a (step S243).

Next, the main CPU 71 determines whether or not, among the four consecutive special symbols (the special symbols are the “DRAGON” symbols or the “TIGER” symbols) whose kind is the same, to be rearranged in the display regions among the symbol display regions 4, which correspond to the first video reel 3a, one to three special symbols whose kind is the same are rearranged (step S244). When this determination is YES, the main CPU 71 displays the first video reel 3a in the moving manner in the upward direction or the downward direction and rearranges the four consecutive special symbols whose kind is the same (step S245). In other words, the first video reel 3a is nudged. After the processing at step S245 has been finished, the main CPU 71 shifts the processing to step S246. Alternatively, when the determination at step S244 is NO, that is, when the four consecutive special symbols whose kind is the same have already been rearranged in the display regions which correspond to the first video reel 3a or no special symbols are rearranged at all, the main CPU 71 shifts the processing to step S246. Accordingly, when step S246 is executed, there is either a case where the four special symbols whose kind is the same have been rearranged on the first video reel 3a or a case where no special symbols are rearranged at all on the first video reel 3a.

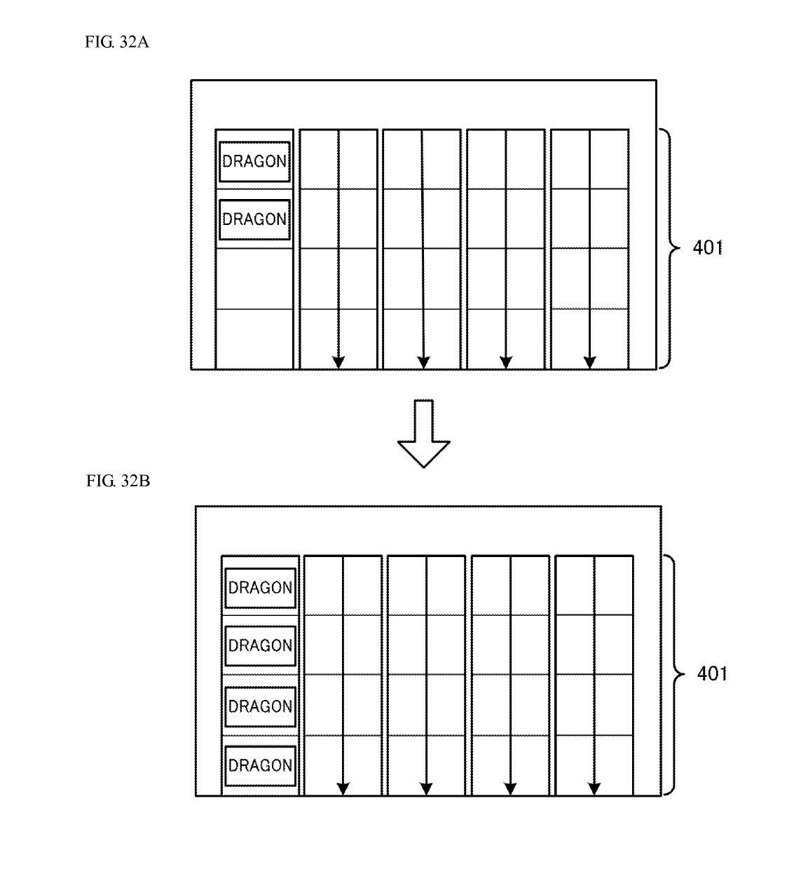

At step S246, the main CPU 71 stops the scrolling of the symbol arrays of the second video reel 3b to fifth video reel 3e. Next, the main CPU 71 determines whether or not the four consecutive special symbols whose kind is the same are rearranged in the display regions which correspond to the first video reel 3a (step S247). When this determination is YES, the main CPU 71 determines whether or not one or more special symbols whose kind is the same as that of said special symbols are rearranged in the display regions which correspond to the second video reel 3b to fifth video reel 3e (step S248). When this determination is YES, the main CPU 71 displays the video reels 3, in the moving manner in the upward direction or the downward direction, which correspond to the display regions in which the one or more special symbols whose kind is the same as that of said special symbols are rearranged such that the special symbols whose kind is the same become the four consecutive symbols and further conducts the rearrangement (step S249). In other words, said video reels 3 are nudged. After this processing has been conducted, the upon-free-game symbol display control processing related to the modified example is finished. In addition, when the determination at step S247 or step S248 is NO, the upon-free-game symbol display control processing related to the modified example is finished. Effects in the upon-free-game symbol display control processing related to the modified example will be described later with reference to FIGS. 32A and 32B and the like.

FIG. 32A illustrates a view in which the processing at step S243 in FIG. 31 is executed and the “DRAGON” symbols which are the special symbols are rearranged in the top display region and the second display region from the top, among the symbol display regions 4, which correspond to the first video reel 3a. FIG. 32B illustrates a view in which the processing at step S245 in FIG. 31 is executed, the first video reel 3a is nudged, and the four consecutive special symbols whose kind is the same are rearranged in the display regions among the symbol display regions 4, which correspond to the first video reel 3a.

As shown in FIG. 32B, after the four consecutive special symbols whose kind is the same have been rearranged in the display regions among the symbol display regions 4, which correspond to the first video reel 3a, the processing at step S246 to S249 in FIG. 31 is executed, and the effects shown in FIGS. 26A to 26C as one example are executed.

It is to be noted that when the processing at step S243 in FIG. 31 is executed, that is, when the scrolling of the first video reel 3a is stopped and the four consecutive special symbols whose kind is the same are rearranged in the display regions among the symbol display regions 4, which correspond to the first video reel 3a, the determination at step S244 is NO. Therefore, since the processing at step S245 is not executed, the effects shown in FIG. 32A are not executed and the effects shown in FIGS. 26A to 26C as one example are executed.

In addition, regardless of either the case where at step S243 in FIG. 31, upon stopping the first scrolling of the first video reel 3a, the four consecutive special symbols whose kind is the same are rearranged or the case where at step S245 in FIG. 31, upon stopping the second scrolling of the first video reel 3a, the four consecutive special symbols whose kind is the same are rearranged, the effects shown in FIGS. 27A to 30B are executed.

### REFERENCE SIGNS LIST

13 main door
3a, 3b, 3c, 3d, 3e video reel
31 spin button
71 main CPU
72 ROM
73 RAM

What is claimed is:

1. A gaming machine in which a payout is determined based on rearranged symbols, comprising
a controller for controlling a game in which along a plurality of scroll lines defined in display regions of a display, a plurality of symbols including a predetermined number or more of consecutive particular symbols are displayed in a moving manner and are rearranged, the controller being programmed to execute processing (1-1) to (1-4) described below:
processing (1-1) in which symbols to be rearranged in a first game are randomly determined;
processing (1-2) in which when the randomly determined and rearranged symbols in the first game satisfy a first condition, a second game is controlled to be started;
processing (1-3) in which symbols to be rearranged in the second game are randomly determined; and
processing (1-4) in which when as a result of the rearrangement of the randomly determined symbols in the second game, the predetermined number of the particular symbols are consecutively rearranged on any of the plurality of scroll lines and at least one of the particular symbols is rearranged on a scroll line which is different from the scroll line on which the predetermined number of the particular symbols have been consecutively rearranged, the predetermined number of the particular symbols are consecutively rearranged on said scroll line on which the at least one of the particular symbols has been rearranged.

2. The gaming machine according to claim 1, wherein
a number of symbols to be rearranged on each of the scroll lines defined in the display regions is a predetermined number,
the predetermined number or more of the particular symbols are consecutively arranged previously in symbol arrays in which the plurality of symbols are arranged, and
the processing (1-4) includes
processing in which when as the result of the rearrangement of the randomly determined symbols in the second game, the predetermined number of the particular symbols are consecutively rearranged on any of the plurality of scroll lines and the at least one of the particular symbols is rearranged on the scroll line which is different from the scroll line on which the predetermined number of the particular symbols have been consecutively rearranged, the symbol arrays are nudged in the same direction in which the plurality of symbols are displayed in the moving manner or in a direction opposite to the same direction such that the predetermined number of the particular symbols are consecutively rearranged on said scroll line on which the at least one of the particular symbols has been rearranged.

3. The gaming machine according to claim 2, wherein
the controller further executes processing (1-5) described below,
processing (1-5) in which as a result of the processing (1-4), when the predetermined number of the particular symbols are consecutively rearranged on all of the plurality of scroll lines, a jackpot is provided.

4. The gaming machine according to claim 2, wherein
the processing (1-2) includes
processing (1-2-1) in which upon starting the second game, a number of games in the second game is set to a predetermined number of games, and the second game is controlled such that the second game is repeated until the number of games in the second game reaches zero,
the processing (1-4) includes
processing (1-4-1) in which when rearranged symbols in the second game satisfy the first condition, the predetermined number of games is added to a number of games in the second game.

5. A gaming machine in which a payout is determined based on rearranged symbols, comprising
a controller for controlling a game in which along a plurality of scroll lines defined in display regions of a display, a plurality of symbols including a predetermined number or more of consecutive particular symbols are displayed in a moving manner and are rearranged, the controller being programmed to execute processing (2-1) to (2-4) described below:
processing (2-1) in which symbols to be rearranged in a first game are randomly determined;
processing (2-2) in which when the randomly determined and rearranged symbols in the first game satisfy a first condition, a second game is controlled to be started;
processing (2-3) in which symbols to be rearranged in the second game are randomly determined; and
processing (2-4) in which when as a result of the rearrangement of the randomly determined symbols in the second game, the predetermined number of the particular symbols are consecutively rearranged on a scroll line, among the plurality of scroll lines, on which symbols have been initially rearranged and at least one of the particular symbols is rearranged on a scroll line which is different from said scroll line on which the symbols have been initially rearranged, the predetermined number of the particular symbols are consecutively rearranged on said scroll line on which the at least one of the particular symbols has been rearranged.

6. The gaming machine according to claim 5, wherein
a number of symbols to be rearranged on each of the scroll lines defined in the display regions is a predetermined number,
the predetermined number or more of the particular symbols are consecutively arranged previously in symbol arrays in which the plurality of symbols are arranged, and
the processing (2-4) includes
processing in which when as the result of the rearrangement of the randomly determined symbols in the second game, the predetermined number of the particular symbols are consecutively rearranged on the scroll line, among the plurality of scroll lines, on which the symbols have been initially rearranged and the at least one of the particular symbols is rearranged on the scroll line which is different from said scroll line on which the symbols have been initially rearranged, the symbol arrays are nudged in the same direction in which the plurality of symbols are displayed in the moving manner or in a direction opposite to the same direction such that the predetermined number of the particular symbols are consecutively rearranged on said scroll line on which the at least one of the particular symbols has been rearranged.

7. The gaming machine according to claim 6, wherein
the controller further executes processing (2-5) described below,
processing (2-5) in which as a result of the processing (2-4), when the predetermined number of the particular symbols are consecutively rearranged on all of the plurality of scroll lines, a jackpot is provided.

8. The gaming machine according to claim 6, wherein
the processing (2-2) includes
processing (2-2-1) in which upon starting the second game, a number of games in the second game is set to a predetermined number of games, and the second game is controlled such that the second game is repeated until the number of games in the second game reaches zero, and
the processing (2-4) includes
processing (2-4-1) in which when rearranged symbols in the second game satisfy the first condition, the predetermined number of games is added to a number of games in the second game.

9. A gaming machine in which a payout is determined based on rearranged symbols, comprising
a controller for controlling a game in which along a plurality of scroll lines defined in display regions of a display, a plurality of symbols including a predetermined number or more of consecutive particular symbols are displayed in a moving manner and are rearranged, the controller being programmed to execute processing (3-1) to (3-5) described below:
processing (3-1) in which symbols to be rearranged in a first game are randomly determined;
processing (3-2) in which when the randomly determined and rearranged symbols in the first game satisfy a first condition, a second game is controlled to be started;
processing (3-3) in which symbols to be rearranged in the second game are randomly determined;
processing (3-4) in which in the second game, at a point in time when symbols are rearranged on a scroll line, among the plurality of scroll lines, on which the symbols are to be initially rearranged, when at least one of the particular symbols is rearranged on said scroll line, a predetermined number of said particular symbols are consecutively rearranged on said scroll line; and
processing (3-5) in which in the second game, when as a result of the rearrangement of the randomly determined symbols on a scroll line which is different from the scroll line on which the predetermined number of the particular symbols have been consecutively rearranged, at least one of the particular symbols is rearranged on said different scroll line, the predetermined number of the particular symbols are consecutively rearranged on said scroll line on which the at least one of the particular symbols has been rearranged.

10. The gaming machine according to claim 9, wherein
a number of symbols to be rearranged on each of the scroll lines defined in the display regions is a predetermined number,
the predetermined number or more of the particular symbols are consecutively arranged previously in symbol arrays in which the plurality of symbols are arranged, and
the processing (3-4) includes
processing in which in the second game, at the point in time when the symbols are rearranged on the scroll line, among the plurality of scroll lines, on which the symbols are to be initially rearranged, when the at least one of the particular symbols is rearranged on said scroll line, the symbol arrays are nudged in the same direction in which the plurality of symbols are displayed in the moving manner or in a direction opposite to the same direction such that the predetermined number of the particular symbols are consecutively rearranged on said scroll line, and
the processing (3-5) includes
processing in which in the second game, when as the result of the rearrangement of the randomly determined symbols on the scroll line which is different from the scroll line on which the predetermined number of the particular symbols have been consecutively rearranged, the at least one of the particular symbols is rearranged on said different scroll line, the symbol arrays are nudged in the same direction in which the plurality of symbols are displayed in the moving manner or in the direction opposite to the same direction such that the predetermined number of the particular symbols are consecutively rearranged on said scroll line on which the at least one of the particular symbols has been rearranged.

11. The gaming machine according to claim 10, wherein
the controller further executes processing (3-6) described below,
processing (3-6) in which as a result of the processing (3-5), when the predetermined number of the particular symbols are consecutively rearranged on all of the plurality of scroll lines, a jackpot is provided.

12. The gaming machine according to claim 10, wherein
the processing (3-2) includes
processing (3-2-1) in which upon starting the second game, a number of games in the second game is set to a predetermined number of games, and the second game is controlled such that the second game is repeated until the number of games in the second game reaches zero, and
the processing (3-5) includes
processing (3-5-1) in which when rearranged symbols in the second game satisfy the first condition, the predetermined number of games is added to a number of games in the second game.

13. The gaming machine according to claim 2, wherein when as the result of the rearrangement of the randomly determined symbols in the second game, the predetermined number of the particular symbols are consecutively rearranged on any of the plurality of scroll lines and the at least one of the particular symbols is rearranged on the scroll line which is different from the scroll line on which the predetermined number of the particular symbols have been consecutively rearranged,
the processing (1-4) includes:
processing (1-4-1) in which when a symbol, rearranged in the bottommost, among the predetermined number of the symbols rearranged along the scroll line on which said at least one of the particular symbols has been rearranged is the particular symbol and a symbol, rearranged in the topmost, among the predetermined number of the symbols is not the particular symbol, the symbol array is nudged in an upward direction such that the predetermined number of the particular symbols are consecutively rearranged on said scroll line; and
processing (1-4-2) in which when a symbol, rearranged in the topmost, among the predetermined number of the symbols rearranged along the scroll line on which said at least one of the particular symbols has been rearranged is the particular symbol and a symbol, rearranged in the bottommost, among the predetermined number of the symbols is not the particular symbol, the symbol array is nudged in a downward direction such that the predetermined number of the particular symbols are consecutively rearranged on said scroll line.

14. The gaming machine according to claim 6, wherein when as the result of the rearrangement of the randomly determined symbols in the second game, the predetermined number of the particular symbols are consecutively rearranged on the scroll line, among the plurality of scroll lines, on which the symbols have been initially rearranged and the at least one of the particular symbols is rearranged on the scroll line which is different from said scroll line on which the symbols have been initially rearranged,
the processing (2-4) includes:
processing (2-4-1) in which when a symbol, rearranged in the bottommost, among the predetermined number of the symbols rearranged along the scroll line on which said at least one of the particular symbols has been rearranged is the particular symbol and a symbol, rearranged in the topmost, among the predetermined number of the symbols is not the particular symbol, the symbol array is nudged in an upward direction such that the predetermined number of the particular symbols are consecutively rearranged on said scroll line; and
processing (2-4-2) in which when a symbol, rearranged in the topmost, among the predetermined number of the symbols rearranged along the scroll line on which said at least one of the particular symbols has been rearranged is the particular symbol and a symbol, rearranged in the bottommost, among the predetermined number of the symbols is not the particular symbol, the symbol array is nudged in a downward direction such that the predetermined number of the particular symbols are consecutively rearranged on said scroll line.

15. The gaming machine according to claim 10, wherein in the second game, at the point in time when the symbols are rearranged on the scroll line, among the plurality of scroll lines, on which the symbols are to be initially rearranged, when the at least one of the particular symbols is rearranged on said scroll line,
the processing (3-4) includes:
processing (3-4-1) in which when a symbol, rearranged in the bottommost, among the predetermined number of the symbols rearranged along said scroll line is the particular symbol and a symbol, rearranged in the topmost, among the predetermined number of the symbols is not the particular symbol, the symbol array is nudged in an upward direction such that the predetermined number of the particular symbols are consecutively rearranged on said scroll line; and
processing (3-4-2) in which when a symbol, rearranged in the topmost, among the predetermined number of the symbols rearranged along said scroll line is the particular symbol and a symbol, rearranged in the bottommost, among the predetermined number of the symbols is not the particular symbol, the symbol array is nudged in a downward direction such that the predetermined number of the particular symbols are consecutively rearranged on said scroll line,
the processing (3-5) includes:
processing (3-5-1) in which when a symbol, rearranged in the bottommost, among the predetermined number of the symbols rearranged along the scroll line on which said at least one of the particular symbols has been rearranged is the particular symbol and a symbol, rearranged in the topmost, among the predetermined number of the symbols is not the particular symbol, the symbol array is nudged in an upward direction such that the predetermined number of the particular symbols are consecutively rearranged on said scroll line; and
processing (3-5-2) in which when a symbol, rearranged in the topmost, among the predetermined number of the symbols rearranged along the scroll line on which said at least one of the particular symbols has been rearranged is the particular symbol and a symbol, rearranged in the bottommost, among the predetermined number of the symbols is not the particular symbol, the symbol array is nudged in a downward direction such that the predetermined number of the particular symbols are consecutively rearranged on said scroll line.

16. A gaming machine in which a payout is determined based on rearranged symbols, comprising
a controller for controlling a game in which along scroll lines, whose number is N, defined in display regions of a display, a plurality of symbols including a predetermined number or more of consecutive particular symbols are displayed in a moving manner and are rearranged, the controller being programmed to execute processing (4-1) to (4-5) described below:
processing (4-1) in which symbols to be rearranged in a first game are randomly determined;
processing (4-2) in which when the randomly determined and rearranged symbols in the first game satisfy a first condition, a second game is controlled to be started;
processing (4-3) in which symbols to be rearranged in the second game are randomly determined;
processing (4-4) in which in the second game, after displaying the symbols in the moving manner on each of the scroll lines whose number is the N, the symbols are sequentially rearranged along each of the scroll lines; and
processing (4-5) in which when as a result of the rearrangement of the symbols in the second game, the predetermined number of the particular symbols are consecutively rearranged on a scroll line, among the scroll lines whose number is the N, on which the symbols have been initially rearranged and at least one of the particular symbols is rearranged on a scroll line which is different from said scroll line on which the symbols have been initially rearranged, the predetermined number of the particular symbols are consecutively rearranged on said scroll line on which the at least one of the particular symbols has been rearranged, and
the processing (4-4) includes
processing in which when the predetermined number of the particular symbols are consecutively rearranged on the scroll line, among the scroll lines whose number is the N, on which the symbols have been initially rearranged, as compared with when the predetermined number of the particular symbols are not consecutively rearranged on the scroll line, among the scroll lines whose number is the N, on which the symbols have been initially rearranged, the symbols are displayed in the moving manner over a long period of time on a scroll line, among the scroll lines whose number is the N, on which the second rearrangement of the symbols is to be conducted.

17. The gaming machine according to claim 16, wherein the processing (4-4) includes
processing in which when the predetermined number of the particular symbols are consecutively rearranged on the scroll line, among the scroll lines whose number is the N, on which the symbols have been initially rearranged and at least one of the particular symbols is rearranged on each of the scroll lines, among the scroll lines whose number is the N, on which said second to the Kth (K is an integer of 2 to (N−1)) rearrangements of the symbols have been conducted, as compared with when even one particular symbol is not rearranged on at least one scroll line among the scroll lines on which said second to the Kth rearrangements of the symbols have been conducted, the symbols are displayed in the moving manner over a long period of time on a scroll line, among the scroll lines whose number is the N, on which the (K+1)th rearrangement of the symbols is to be conducted.

18. The gaming machine according to claim 16, wherein the controller is programmed to execute
processing (4-6) in which when on the scroll line, among the scroll lines whose number is the N, on which the symbols have been initially rearranged, the predetermined number of the particular symbols have been consecutively rearranged, one picture is displayed, instead of the predetermined number of the particular symbols, over a predetermined period of time after the rearrangement of the predetermined number of the particular symbols on said scroll line on which the symbols have been initially rearranged.
